(19) United States
(12) Patent Application Publication
(10) Pub. No.: US 2025/0025865 A1
(43) Pub. Date: Jan. 23, 2025

(54) COCATALYST FOR HYDROGEN GENERATION , PHOTOCATALYST, HYDROGEN PRODUCTION METHOD, HYDROGEN PRODUCTION APPARATUS, AND SEMICONDUCTOR MATERIAL

(71) Applicant: TOHOKU UNIVERSITY, Sendai-shi, Miyagi (JP)

(72) Inventors: Ryota SAKAMOTO, Sendai-shi (JP); Ryu ABE, Kyoto-shi (JP); Jingyan GUAN, Kyoto-shi (JP); Hajime SUZUKI, Kyoto-shi (JP)

(21) Appl. No.: 18/572,292

(22) PCT Filed: Jun. 21, 2022
(86) PCT No.: PCT/JP2022/024714

§ 371 Date: Sep. 13, 2024

(30) Foreign Application Priority Data
Jun. 22, 2021 (JP) 2021-103593

(51) Int. Cl. B01J 31/16; B01J 23/02; B01J 23/78; B01J 35/39; C01B 3/04

(52) U.S. Cl. CPC B01J 31/1691; B01J 23/02; B01J 23/78; B01J 35/39; C01B 3/042

(57) ABSTRACT

The cocatalyst for hydrogen generation is a cocatalyst for hydrogen generation to be combined with a semiconductor catalyst that is excited by light and includes a metal-organic framework having a molecular structure represented by the following formula (1). In the formula (1), M is at least one selected from Ni, Co, Fe, Cu, Zn, Pd, Pt, Au, and Ir, L¹ to L⁴ are each independently at least one selected from S, Se, Te, NH, and O, C¹ and C² are carbon atoms forming a first aromatic group, and C³ and C⁴ are carbon atoms forming a second aromatic group.

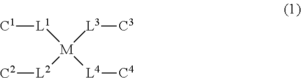

### CROSS-REFERENCE TO RELATED APPLICATIONS

This application is the U.S. National Stage entry of International Application No. PCT/JP2022/024714, filed on Jun. 21, 2022, which, in turn, claims priority to Japanese Patent Application No. 2021-103593, filed on Jun. 22, 2021, both of which are hereby incorporated herein by reference in their entireties for all purposes.

### TECHNICAL FIELD

The present invention relates to a cocatalyst for hydrogen generation, a photocatalyst, a method for producing hydrogen, a hydrogen production apparatus, and a semiconductor material.

### BACKGROUND ART

In recent years, development and utilization of an energy that does not depend on fossil resources such as petroleum have been demanded, and hydrogen (H₂) has been attracting attention as a carrier of the energy. However, most of the hydrogen currently used is produced by reforming natural gas, and carbon dioxide emission accompanying the production is regarded as a problem. On the other hand, as a clean hydrogen production method without discharging carbon dioxide, there is known water decomposition using a semiconductor material that is excited by light as a photocatalyst. Patent Document 1 discloses a semiconductor material that can be used as the photocatalyst.

### CITATION LIST

### Patent Document

Patent Document 1: JP 2017-154959 A

### SUMMARY OF INVENTION

### Technical Problem

Patent Document 1 describes that the photocatalyst may include a cocatalyst and that a metal such as Pt or a metal oxide such as NiOₓ can be used as a cocatalyst for a hydrogen generation reaction (cocatalyst for hydrogen generation). With the cocatalyst, it is expected to improve hydrogen generation efficiency by photodecomposition due to suppression of recombination of excited carriers generated in a semiconductor material by light irradiation, promotion of a surface reaction, and the like. However, according to the studies by the present inventors, these cocatalysts in the related art are still insufficient for further improvement of the hydrogen generation efficiency.

The present invention is directed to providing a novel cocatalyst for hydrogen generation suitable for further improving the generation efficiency of hydrogen by a photocatalyst.

### Solution to Problem

The present invention provides
a cocatalyst for hydrogen generation to be combined with a semiconductor catalyst that is excited by light, the cocatalyst for hydrogen generation including
a metal-organic framework having a molecular structure represented by the following formula (1).

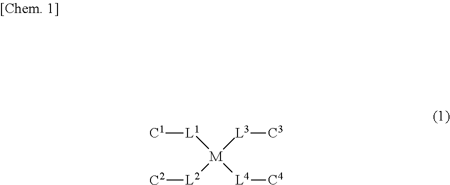

In the formula (1), M is at least one selected from Ni, Co, Fe, Cu, Zn, Pd, Pt, Au, and Ir,
L¹ to L⁴ are each independently at least one selected from S, Se, Te, NH, and O,
C¹ and C² are carbon atoms forming a first aromatic group, and
C³ and C⁴ are carbon atoms forming a second aromatic group.

When viewed from another aspect, the present invention provides
a photocatalyst including:
a semiconductor catalyst that is excited by light; and
the cocatalyst for hydrogen generation of the present invention.

When viewed from another aspect, the present invention provides
a method for producing hydrogen including
irradiating the photocatalyst of the present invention with light including at least one selected from ultraviolet light, visible light, and near-infrared light to decompose water to produce hydrogen.

When viewed from another aspect, the present invention provides
a hydrogen production apparatus including
a reaction unit including the photocatalyst of the present invention.

When viewed from another aspect, the present invention provides
a semiconductor material including:
a semiconductor that is excited by light; and
a metal-organic framework having a molecular structure represented by the following formula (1).

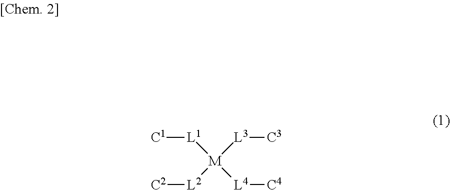

In the formula (1), M is at least one selected from Ni, Co, Fe, Cu, Zn, Pd, Pt, Au, and Ir,
L¹ to L⁴ are each independently at least one selected from S, Se, Te, NH, and O,
C¹ and C² are carbon atoms forming a first aromatic group, and
C³ and C⁴ are carbon atoms forming a second aromatic group.

### Advantageous Effects of Invention

According to the present invention, it is possible to provide a novel cocatalyst for hydrogen generation suitable for further improving the efficiency of hydrogen generation by a photocatalyst.

### BRIEF DESCRIPTION OF DRAWINGS

FIG. 1 is a conceptual diagram schematically illustrating an example of water decomposition using a semiconductor material as a photocatalyst and a hydrogen generation reaction mechanism by the water decomposition.

FIG. 2 is a conceptual diagram illustrating an example of a presumed mechanism for promoting a reduction reaction of water in a cocatalyst for hydrogen generation of the present invention.

FIG. 3A is a diagram illustrating examples of an aromatic group which can be possessed by a metal-organic framework included in a cocatalyst for hydrogen generation of the present invention.

FIG. 3B is a diagram illustrating examples of a ligand which can be possessed by a metal-organic framework included in the cocatalyst for hydrogen generation of the present invention.

FIG. 4A is an observation image of SrTiO₃:Al prepared in Example 1 by a scanning electron microscope (SEM).

FIG. 4B is an observation image of NiDT prepared in Example 1 by SEM.

FIG. 4C is an observation image of NiDT/SrTiO₃:Al prepared in Example 1 by SEM.

FIG. 4D is a sulfur element mapping image of NiDT/SrTiO₃:Al prepared in Example 1 by energy dispersive X-ray spectrometry (EDX).

FIG. 4E is a titanium element mapping image of NiDT/SrTiO₃:Al prepared in Example 1 by EDX.

FIG. 5 is a graph showing changes over time in an amount of hydrogen generated in a case where each of SrTiO₃:Al and NiDT/SrTiO₃:Al prepared in Example 1 was used as a photocatalyst.

FIG. 6 shows measurement results of linear sweep voltammetry (LSV) for SrTiO₃:Al and NiDT/SrTiO₃:Al prepared in Example 1.

FIG. 7 is a graph showing generation rates of hydrogen and oxygen (gas generation rates) in the case where each of SrTiO₃:Al and NiDT/SrTiO₃:Al prepared in Example 1 was used as the photocatalyst.

FIG. 8 is a graph showing changes over time in amounts of hydrogen and oxygen generated in a case where a cycle test was carried out using NiDT/SrTiO₃:Al prepared in Example 1 as the photocatalyst.

FIG. 9 is a graph showing generation rates of hydrogen and oxygen in the case where NiDT/SrTiO₃:Al prepared in Example 1 was used as the photocatalyst and in a case where SrTiO₃:Al prepared in Example was used as the photocatalyst and an aqueous nickel nitrate solution was added to a reaction solution.

FIG. 10A is an observation image of NiDT/SrTiO₃:Al prepared in Example after a water decomposition reaction for 120 hours by SEM.

FIG. 10B is an EDX profile of NiDT/SrTiO₃:Al prepared in Example before and after the water decomposition reaction for 120 hours.

FIG. 11 is a graph showing generation rates of hydrogen and oxygen in a case where each of NiDT/CoOₓ/SrTiO₃:Al, CoOₓ/SrTiO₃:Al, and NiDT/SrTiO₃:Al prepared in Example 1 was used as the photocatalyst.

FIG. 12 is a graph showing changes over time in amounts of hydrogen and oxygen generated in a case where each of NiDT/CoOₓ/SrTiO₃:Al and Pt/CoOₓ/SrTiO₃:Al prepared in Example was used as the photocatalyst.

FIG. 13 is a graph showing changes over time of pressure of a closed system accommodating hydrogen and oxygen in a case where each of NiDT/SrTiO₃:Al and Pt/SrTiO₃:Al prepared in Example was placed in the closed system.

FIG. 14 is an observation image of CoDT prepared in Example 2 by SEM.

FIG. 15 is a graph showing changes over time in amounts of hydrogen and oxygen generated in a case where CoDT/SrTiO₃:Al prepared in Example 2 was used as the photocatalyst.

FIG. 16 is an observation image of CoDT/SrTiO₃:Al prepared in Example 2 after the water decomposition reaction for 22 hours by SEM.

FIG. 17 is an observation image of NiDT-NCs prepared in Example 3 by SEM.

FIG. 18 is a graph showing changes over time in amounts of hydrogen and oxygen generated in a case where NiDT-NCs/CoOₓ/SrTiO₃:Al prepared in Example 3 was used as the photocatalyst.

FIG. 19 is a graph showing changes over time in amounts of hydrogen and oxygen generated in a case where NiDT-NCs/SrTiO₃:Al prepared in Example 3 was used as the photocatalyst.

FIG. 20 is a graph showing a relationship between an addition amount of NiDT-NCs and gas generation rates of hydrogen and oxygen in a case where NiDT-NCs/SrTiO₃:Al prepared in Example 4 was used as the photocatalyst.

FIG. 21A is a graph showing changes over time in amounts of hydrogen and oxygen generated in a case where CuCo-CAT/SrTiO₃:Al prepared in Example 5 was used as the photocatalyst.

FIG. 21B is a graph showing changes over time in amounts of hydrogen and oxygen generated in a case where CuCo-CAT/CoOₓ/SrTiO₃:Al prepared in Example 5 was used as the photocatalyst.

FIG. 22 is a graph showing changes over time in amounts of hydrogen and oxygen generated in a case where CuNi-CAT/SrTiO₃:Al prepared in Example 6 was used as the photocatalyst.

### DESCRIPTION OF EMBODIMENTS

Hereinafter, an embodiment of the present invention will be described. The present invention is not limited to the embodiment described below.

### Cocatalyst for Hydrogen Generation

A cocatalyst for hydrogen generation of the present embodiment includes a metal-organic framework (A) having a molecular structure represented by the following formula (1).

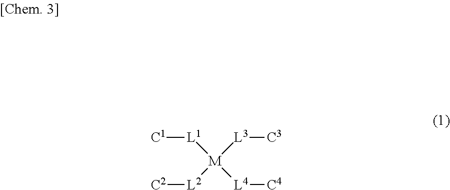

In the formula (1), M is at least one selected from Ni, Co, Fe, Cu, Zn, Pd, Pt, Au, and Ir,
L¹ to L⁴ are each independently at least one selected from S, Se, Te, NH, and O,
C¹ and C² are carbon atoms forming a first aromatic group, and
C³ and C⁴ are carbon atoms forming a second aromatic group.

Typically, the molecular structure of the formula (1) is a kind of complex structure in which M is a metal nucleus and each of a structure including a first aromatic group, L¹, and L² and a structure including a second aromatic group, L³, L⁴ is a ligand (organic ligand). In a typical example, the molecular structure of the formula (1) has a planar four-coordinate structure.

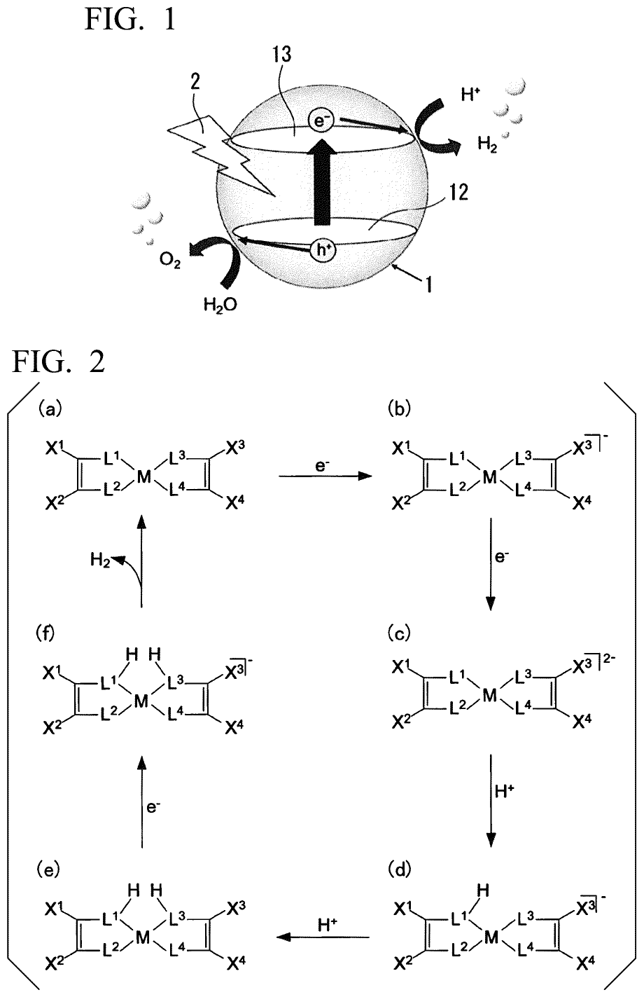

FIG. 1 schematically illustrates an example of a mechanism of water decomposition using a semiconductor material as a photocatalyst and a mechanism of a hydrogen generation reaction by water decomposition. As illustrated in FIG. 1, when a semiconductor material 1 is irradiated with light 2 having an energy equal to or higher than a predetermined level, electrons in a valence band 12 are excited to a conduction band 13 to generate photoexcited carriers (excited electrons (e⁻) and holes (h⁺)). The generated excited electrons and holes reach a surface of the semiconductor material 1 to reduce and oxidize water, respectively, thereby generating hydrogen (H₂) and oxygen (O₂). The metal-organic framework (A) has an ability to capture the excited electrons that have reached the surface of the semiconductor material 1 and to promote a reduction reaction of water (more specifically, a reduction reaction of hydrogen ions (H⁺) in water) on the surface.

FIG. 2 illustrates an example of a presumed mechanism for promoting the reduction reaction of water in the metal-organic framework (A). In FIG. 2, the first aromatic group is represented by two carbon atoms corresponding to C¹ and C², X¹, and X², and the second aromatic group is represented by two carbon atoms corresponding to C³ and C⁴, X³, and X⁴. In other words, X¹ and X² together with the two carbon atoms corresponding to C¹ and C² form the first aromatic group and X³ and X⁴ together with the two carbon atoms corresponding to C³ and C⁴ form the second aromatic group. As illustrated in FIG. 2, a state of the metal-organic framework (A) changes from (a) in which nothing is captured to (b) and (c) by capturing the excited electrons (e⁻) generated in the semiconductor material, and then changes to (d) and (e) by capturing the hydrogen ions (H⁺). Thereafter, the state changes from (e) to (f) in this order by further capturing the excited electrons (e⁻). When the state of the metal-organic framework (A) reaches the state (f), hydrogen is generated by reduction of a pair of hydrogen ions captured, and the state of the metal-organic framework (A) returns to the state (a). The metal-organic framework (A) that has returned to the state (a) can capture the excited electrons and hydrogen ions again. Further, as illustrated in FIG. 2, the change in state progresses only in the direction from (a) to (f) through (b). (c) . . . and does not progress in the reverse direction. In other words, the reaction due to the change in state is selective, and a reduction reaction of oxygen (reaction in which water is generated from hydrogen and oxygen), which is a reverse reaction, is inhibited. It is known to those skilled in the art that a cocatalyst for hydrogen generation including a metal or a metal oxide may cause a non-negligible reverse reaction that inhibits hydrogen generation. A cocatalyst including the metal-organic framework (A) having the reaction selectivity for inhibiting the reverse reaction is suitable for further improving the efficiency of hydrogen generation by a photocatalyst.

M in the formula (1) may be any one of Ni, Co, Fe, Cu, Zn, Pd, Pt. Au, and Ir, or may be a combination of two or more of these metals. M may be, for example, at least one selected from Ni, Co, and Cu. M may be one that is Ni or one that is Co, or may be two that is a combination of Ni and Cu or two that is a combination of Co and Cu.

L¹ to L⁴ are each independently at least one selected from S, Se, Te, NH, and O. L¹ to L⁴ each independently may be at least one selected from S, Se, Te, and O, may be at least one selected from S, Se, and Te, may be at least one selected from S and Se, may be at least one selected from S and O, may be S, or may be O. All of L¹ to L⁴ may be the same.

In the present specification, the term “aromatic group” means a group derived from an aromatic compound. The aromatic compound includes not only monocyclic compounds but also bicyclic, tricyclic, and polycyclic compounds. Two or more rings may form a condensed ring. The aromatic compound includes not only an aromatic hydrocarbon compound but also a heteroaromatic compound. Examples of the heteroatom of the heteroaromatic compound include N, O, and S. The aromatic compound may be a complex of a cyclic compound having aromaticity and a metal nucleus. Examples of the aromatic compound include benzene, triphenylene, hexaazatriphenylene, tricycloquinoazoline, porphyrin, benzoporphyrin, tetraazaporphyrin, phthalocyanine, subporphyrin, and subphthalocyanine. Examples of the cyclic compound that can form a complex with the metal nucleus include porphyrin, benzoporphyrin, tetraazaporphyrin, phthalocyanine, subporphyrin, and subphthalocyanine. Subporphyrin and subphthalocyanine include benzosubporphyrin and benzosubphthalocyanine, respectively.

At least one selected from the first aromatic group and the second aromatic group may be a group represented by the following formula (2a) or (2b). The group represented by the formula (2a) is a 6-valent group derived from benzene. The group represented by the formula (2b) is a 6-valent group derived from triphenylene.

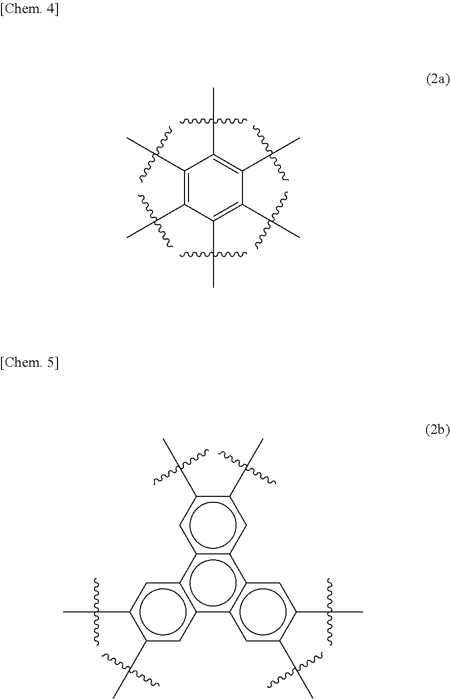

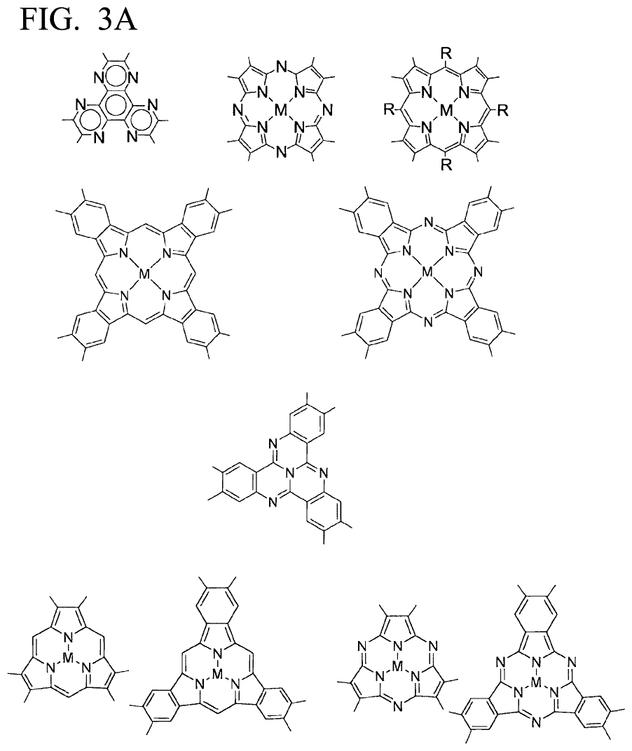

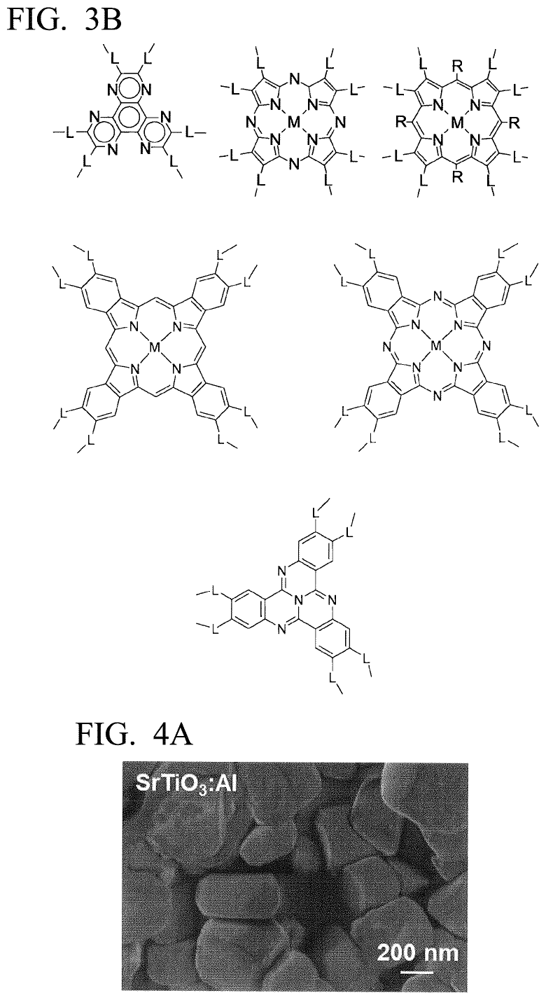

FIG. 3A illustrates other examples of the group that can be taken by at least one selected from the first aromatic group and the second aromatic group. Examples of R which can be taken by the groups illustrated in FIG. 3A include a hydrogen atom, an aliphatic group (such as an alkyl group), and an aromatic group. R may also be a group containing a heteroatom such as an —NR′R″ group. Examples of the metal nucleus M are the same as the examples of M in the formula (1).

The first aromatic group and the second aromatic group may be the same or different from each other.

At least one selected from a first ligand having a structure including the first aromatic group, L¹, and L² and a second ligand having a structure including the second aromatic group, L³, and L⁴ may be a C⁶L⁶ ligand represented by the following formula (3a). L¹¹ to L¹⁶ in the formula (3a) are each independently an element that can be taken by L¹ to L⁴ in the formula (1).

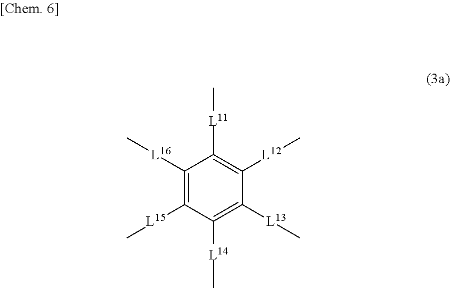

At least one selected from the first ligand having a structure including the first aromatic group, L¹, and L², and the second ligand having a structure including the second aromatic group, L³, and L⁴ may be a triphenylene-derived ligand represented by the following formula (3b). L²¹ to L²⁶ in the formula (3b) are each independently an element that can be taken by L¹ to L⁴ in the formula (1).

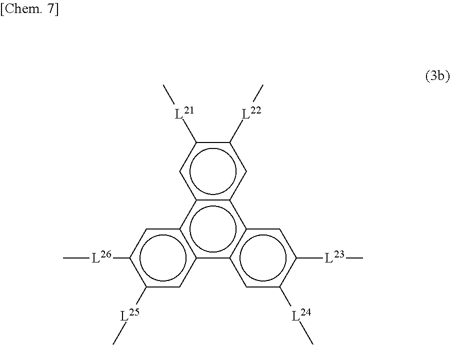

FIG. 3B illustrates other examples of the ligand that can be taken by at least one selected from the first ligand and the second ligand. R and the metal nucleus M in FIG. 3B are the same as R and the metal nucleus M in FIG. 3A, respectively. Each L in FIG. 3B is independently an element that can be taken by L¹ to L⁴ in the formula (1). Each L in FIG. 3B may be independently at least one selected from S. NH, O, and Se.

The first ligand and the second ligand may be the same or different from each other.

In a case where M and L in the formula (1) are Ni and S, respectively, and the first aromatic group and the second aromatic group are groups represented by the formula (2a), the molecular structure of the formula (1) is a bis(dithiolate) nickel structure. In a case where M and L in the formula (1) are Co and S, respectively, and the first aromatic group and the second aromatic group are groups represented by the formula (2a), the molecular structure of the formula (1) is bis(dithiolate) cobalt structure. In the present specification, a metal-organic framework (A) having one or two or more bis(dithiolate) nickel structures and a metal-organic framework (A) having one or two or more bis(dithiolate) cobalt structures are referred to as NiDT and CoDT, respectively.

The metal-organic framework (A) may include two or more molecular structures represented by the formula (1), or may be a polymer having the molecular structure described above. The metal-organic framework (A) that is a polymer body is particularly suitable for further improving the efficiency of hydrogen generation by a photocatalyst. The polymer body may have a structure in which two or more metal atoms (M in the formula (1)) are linked to each other by the first ligand and/or the second ligand.

The polymer body may have a one-dimensional structure in which the molecular structures of the formula (1) are linearly bonded, or may have a two-dimensional structure in which the molecular structures of the formula (1) are planarly bonded. The two-dimensional structure may be a planar structure. An example of the two-dimensional planar structure is shown in the following formula (4). In other words, the cocatalyst for hydrogen generation of the present embodiment may have a molecular structure represented by the following formula (4). The molecular structure of the formula (4) includes a metal atom M and a C₆L₆ ligand and has a six-fold symmetric structure. The molecular structure of the formula (4) has a graphene-like two-dimensional conjugated planar structure, and thus has particularly excellent conductivity and is chemically stable. These points can contribute to further improvement of the efficiency of hydrogen generation by a photocatalyst. In addition, the excellent conductivity is advantageous for construction of Z-Scheme (two-stage excitation energy acquisition mechanism) described below. As the conductivity, for example, an electrical conductivity of 1.0×10² S/cm or higher, and further 1.6×10² S/cm or higher can be achieved.

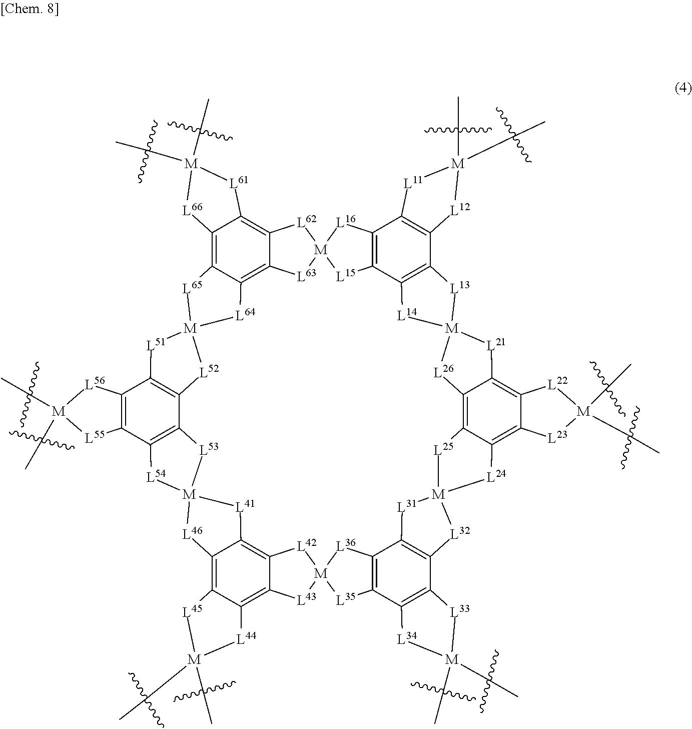

M in the formula (4) is the same as M in the formula (1), that is, at least one selected from Ni, Co, Fe, Cu, Zn, Pd, Pt, Au, and Ir. In the formula (4), M may be, for example, one that is Ni or one that is Co, or may be two that is a combination of Ni and Cu or two that is a combination of Co and Cu. L¹¹ to L¹⁶, L²¹ to L²⁶, L³¹ to L³⁶, L⁴¹ to L⁴⁶, L⁵¹ to L⁵⁶, and L⁶¹ to L⁶⁶ are each independently an element that can be taken by L¹ to L⁴ described above.

An example of the molecular structure of the formula (4) is shown in the following formula (4a). In the formula (4a), M is Ni, and all of L¹¹ to L¹⁶, L²¹ to L²⁶, L³¹ to L³⁶, L⁴¹ to L⁴⁶, L⁵¹ to L⁵⁶, and L⁶¹ to L⁶⁶ are S. The molecular structure of the formula (4a) includes Ni and a benzenehexathiol (C₆S₆) ligand. The metal-organic framework (A) having the molecular structure of the formula (4a) is a kind of NiDT. The C₆S₆ ligand can particularly contribute to further improvement of the efficiency of hydrogen generation by a photocatalyst.

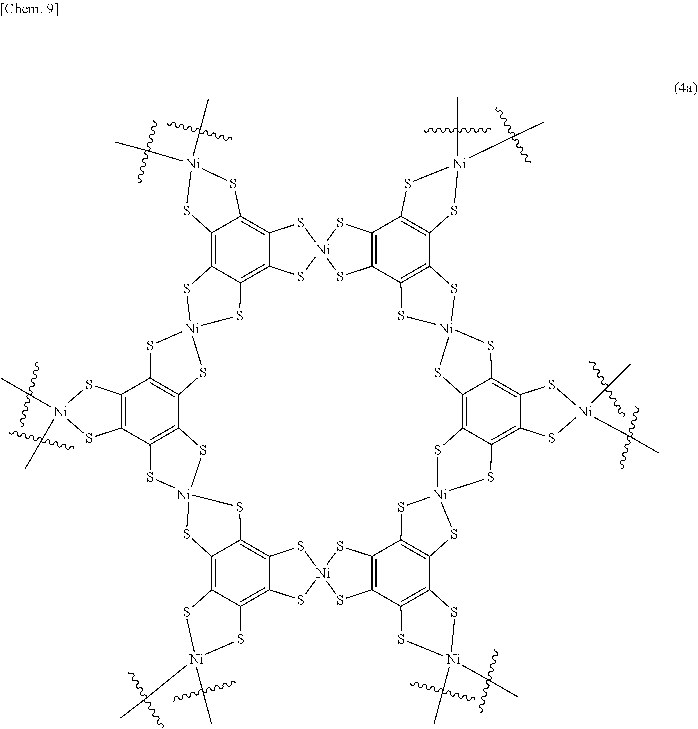

Another example of the two-dimensional planar structure is shown in the following formula (4b). In other words, the cocatalyst for hydrogen generation of the present embodiment may have a molecular structure represented by the following formula (4b). The molecular structure of the formula (4b) includes a metal atom M and a C₆L₆ ligand and has a six-fold symmetric structure. The molecular structure of the formula (4b) has a graphene-like two-dimensional conjugated planar structure.

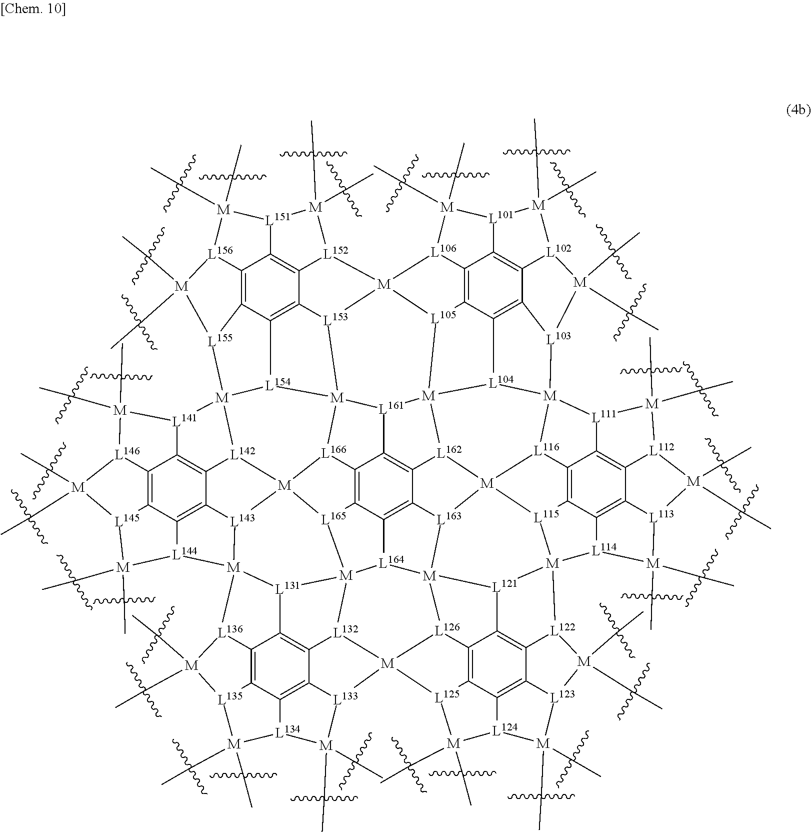

M in the formula (6) is the same as M in the formula (1), that is, at least one selected from Ni, Co, Fe, Cu, Zn, Pd, Pt, Au, and Ir. L¹⁰¹ to L¹⁰⁶, L¹¹¹ to L¹¹⁶, L¹²¹ to L¹²⁶, L 131 to L 136, L 141 to L¹⁴⁶, L 151 to L¹⁵⁶, and L¹⁶¹ to L¹⁶⁶ are each independently an element that can be taken by L¹ to L⁴ described above.

The cocatalyst for hydrogen generation of the present embodiment may have a molecular structure represented by the following formula (5). The molecular structure of the formula (5) includes a metal atom M and a ligand derived from triphenylene and has a six-fold symmetric structure. The molecular structure of the formula (5) has a graphene-like two-dimensional conjugated plane structure, and thus has particularly excellent conductivity and is chemically stable. These points can contribute to further improvement of the efficiency of hydrogen generation by a photocatalyst. In addition, the excellent conductivity is advantageous for construction of Z-Scheme (two-stage excitation energy acquisition mechanism) described below. As the conductivity, for example, an electrical conductivity of 1.0×10² S/cm or higher, and further 1.6×10² S/cm or higher can be achieved.

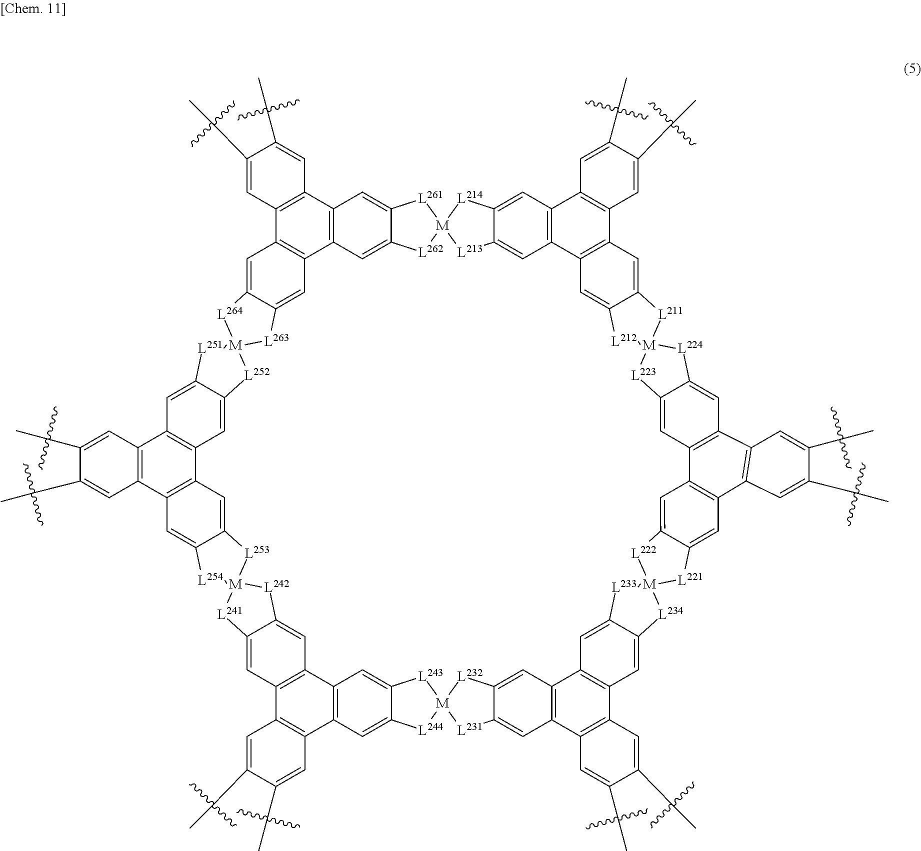

M in the formula (5) is the same as M in the formula (1), that is, at least one selected from Ni, Co, Fe, Cu, Zn, Pd, Pt, Au, and Ir. In the formula (5), M may be, for example, one that is Ni or one that is Co, or may be two that is a combination of Ni and Cu or two that is a combination of Co and Cu. L²¹¹ to L²¹⁴, L²²¹ to L²²⁴, L²³¹ to L²³⁴, L²⁴¹ to L²⁴⁴, L²⁵¹ to L²⁵⁴, and L²⁶¹ to L²⁶⁴ are each independently an element that can be taken by L¹ to L⁴ described above.

An example of the molecular structure of formula (5) is shown in the following formula (5a). In the formula (5a), M is two that is a combination of Co and Cu, and all of L²¹¹ to L²¹⁴, L²²¹ to L²²⁴, L²³¹ to L²³⁴, L²⁴¹ to L²⁴⁴, L²⁵¹ to L²⁵⁴, and L²⁶¹ to L²⁶⁴ are O. The molecular structure of the formula (5a) includes two that is a combination of Co and Cu and a ligand derived from oxytriphenylene. The ligand derived from oxytriphenylene can particularly contribute to further improvement of the efficiency of hydrogen generation by a photocatalyst.

In the present specification, the metal-organic framework (A) having a catecholate structure of the formula (5a) is referred to as CuCo-CAT.

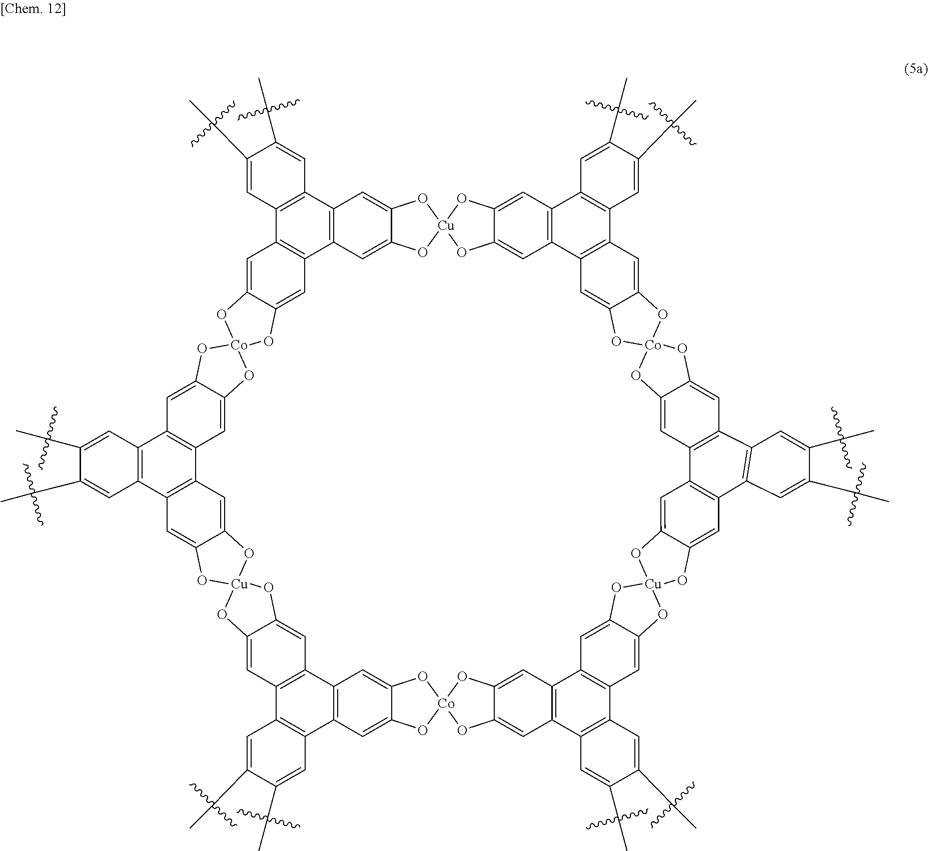

Each of the molecular structures of the formulae (4), (4a), (4b), (5), and (5a) can be a minimum unit constituting the metal-organic framework (A). The molecular structure may further extend by bonding the above-described units to each other at wavy line portions of the formulae (4), (4a), (4b), (5), and (5a). The molecular structure may extend in a planar manner or may form a nanosheet. In other words, the cocatalyst for hydrogen generation of the present embodiment may be a nanosheet including the metal-organic framework (A) (which is not limited to the molecular structures represented by the formulae (4), (4a), (4b), (5), and (5a)), or a laminate including nanosheets laminated. The laminate may be sheet-shaped or particle-shaped. One nanosheet layer has a thickness of usually about 0.3 to 2.0 nm and may have a thickness of 0.5 to 1.0 nm. The laminate including nanosheets laminated has a size (a thickness in a case of the sheet shape, a primary particle size in a case of the particle shape) of, for example, 0.3 to 2000 nm, and may have a size of 50 to 200 nm. For the nanosheet and the sheet-shaped laminate, the size in an in-plane direction is not limited, but may be, for example, 1 nm or more and 10 μm or less, 50 nm or more and 5 μm or less, 100 nm or more and 2 μm or less, 200 nm or more and 1 μm or less, or 500 nm or more and 800 nm or less, in terms of the maximum length, in consideration of the efficiency as a cocatalyst. The sizes of the nanosheet and the laminate can be evaluated by, for example, image analysis of an observation image of the cocatalyst for hydrogen generation by SEM. The size is an average value of values measured for at least 50 cocatalyst for hydrogen generations. The primary particle size of a particle can be determined as a diameter of a circle having an area equal to the area of a particle to be measured on the observation image.

The cocatalyst for hydrogen generation of the present embodiment can be used for generation of hydrogen by being combined with a semiconductor catalyst that is excited by light. Generation of hydrogen is typically carried out by decomposition of water.

Light that excites the semiconductor catalyst is, for example, light including at least one selected from ultraviolet light, visible light, and near-infrared light. The light that excites the semiconductor catalyst may have a wavelength in a range of 300 nm or longer to 1200 nm or shorter.

In a typical example of the semiconductor catalyst with which the cocatalyst for hydrogen generation of the present embodiment is combined, an energy at the lower end of the conduction band in the semiconductor catalyst is negatively larger than a reduction potential of water (hydrogen generation potential).

In an example of the semiconductor catalyst with which the cocatalyst for hydrogen generation of the present embodiment is combined, the energy at the lower end of the conduction band in the semiconductor catalyst is negatively larger than the reduction potential of water, and an energy at the upper end of the valence band is positively larger than an oxidation potential (oxygen generation potential) of water. This example is suitable for generating not only hydrogen but also oxygen by decomposition of water by irradiation with light.

An example of the semiconductor catalyst is at least one selected from the group consisting of SrTiO₃, K₂Ti₆O₁₃, TiO₂, Nb₂O₅, KTaO₃/KNbO₃ solid solution, ZnO, ZrO₂, GaP, GaN, Si, CdS, CdSe, C₃N₄, and metal-doped forms thereof. The energy at the lower end of the conduction band in each of the above examples is negatively larger than the reduction potential of water. For SrTiO₃, KTiO₃, TiO₂, Nb₂O₅, KTaNbO, ZnO, ZrO₂, CdS, CdSe, and C₃N₄, the energy at the upper end of the valence band is positively larger than the oxidation potential of water. The semiconductor catalyst may be at least one selected from SrTiO₃, KTiO₃, KTaNbO, ZrO₂, GaP, CdS, CdSe, and C₃N₄, metal-doped forms thereof, or may be at least one selected from SrTiO₃ and a metal-doped form thereof. Examples of the metal to be used for doping include Al, Ga, In, Rh, Ir, Cr, Sb, La, Na, and Ta. The semiconductor catalyst may be SrTiO₃:Al obtained by doping SrTiO₃ with Al.

The semiconductor catalyst may be a catalyst (including a visible light responsive type) disclosed in each of JP 2017-154959 A. JP 2020-138188 A, and JP 2020-142213 A. However, the semiconductor catalyst is not limited to the above examples.

The semiconductor catalyst may be particle-shaped. The primary particle size of the particle-shaped semiconductor catalyst may be, for example, 1 nm or more and 500 μm or less, 5 nm or more and 20 μm or less, or 10 nm or more and 10 μm or less. The primary particle size of the semiconductor catalyst can be evaluated by, for example, image analysis of an observation image of the semiconductor catalyst by SEM. The primary particle size is an average value of values measured for at least 50 semiconductor catalysts.

The cocatalyst for hydrogen generation of the present embodiment and the semiconductor catalyst can be combined by, for example, mixing them. In addition, the cocatalyst for hydrogen generation and the semiconductor catalyst can be complexed by synthesizing the cocatalyst for hydrogen generation in the presence of the semiconductor catalyst and attaching the generated cocatalyst for hydrogen generation to the surface of the semiconductor catalyst. The cocatalyst for hydrogen generation of the present embodiment may be further combined with a cocatalyst for oxygen generation in addition to the semiconductor catalyst. Examples of the cocatalyst for oxygen generation include metals such as Mg, Ti, Mn, Fe, Co, Ni, Cu, Ga, Ru, Rh, Pd, Ag, Cd, In, Ce, Ta, W, Ir, Pt, and Pb, and oxides and composite oxides thereof. Preferred examples of the cocatalyst for oxygen generation include Mn, Co, Ni, Ru. Rh, and Ir, and oxides and composite oxides thereof, and more preferred examples thereof include Ir, MnOₓ, CoOₓ, NiCoOₓ, RuOₓ, RhOₓ, and IrOₓ.

A photocatalyst in which the cocatalyst for hydrogen generation and the semiconductor catalyst are combined can be used for, for example, hydrogen production or water decomposition. The photocatalyst (first photocatalyst) and another photocatalyst (second photocatalyst) in which the cocatalyst for oxygen generation and the semiconductor catalyst are combined may be used to construct a Z-Scheme in which hydrogen is generated by the first photocatalyst and oxygen is generated by the second photocatalyst. The Z-Scheme is particularly suitable for effective utilization of low-energy light such as visible light and improvement of a degree of freedom in selection of a semiconductor catalyst and design of a photocatalyst.

The photocatalyst in which the cocatalyst for hydrogen generation, the cocatalyst for oxygen generation, and the semiconductor catalyst are combined can be used, for example, for production of hydrogen and oxygen or decomposition of water.

The method and mode of use of the photocatalyst containing the cocatalyst for hydrogen generation of the present embodiment are not limited to the above examples.

The cocatalyst for hydrogen generation of the present embodiment can be formed, for example, by a liquid-liquid interface synthesis method in which a complex forming reaction is allowed to proceed at an interface between a first solution containing a metal atom M (typically containing it as an ion) and a second solution containing an organic ligand and being incompatible with the first solution. In addition, depending on the type of the cocatalyst for hydrogen generation, the cocatalyst for hydrogen generation may be formed by a gas-liquid interface synthesis method in which a second solution containing an organic ligand is dropped onto the surface of a first solution containing a metal atom M (typically containing it as an ion), and a complex formation reaction is allowed to proceed on the surface of the first solution while evaporating a solvent of the second solution. The first solution and the second solution in the liquid-liquid interface synthesis method and the gas-liquid interface synthesis method are, for example, an aqueous solution and an organic solution, respectively. In the liquid-liquid interface synthesis method, a sheet in which nanosheets of the metal-organic framework (A) are laminated is usually obtained. In the gas-liquid interface synthesis method, it is also possible to obtain a single-layer nanosheet of the metal-organic framework (A).

### Photocatalyst

The photocatalyst of the present embodiment includes a semiconductor catalyst that is excited by light and the cocatalyst for hydrogen generation of the present embodiment. Examples of the cocatalyst for hydrogen generation and the semiconductor catalyst, and examples of the method and mode of use of the photocatalyst, including preferred examples, are as described above.

An amount of the cocatalyst for hydrogen generation contained in the photocatalyst may be, for example, 1 part by weight or less, 0.5 parts by weight or less, 0.1 parts by weight or less, 0.01 parts by weight or less, or even 0.001 parts by weight or less, with respect to 100 parts by weight of the semiconductor catalyst. The lower limit of the amount of the cocatalyst for hydrogen generation is, for example, 0.00001 parts by weight or more with respect to 100 parts by weight of the semiconductor catalyst.

In the photocatalyst, the cocatalyst for hydrogen generation is usually in contact with the semiconductor catalyst. The cocatalyst for hydrogen generation and the semiconductor catalyst may be joined to each other. The cocatalyst for hydrogen generation may be supported on the semiconductor catalyst. For example, the photocatalyst may have a configuration in which a fine cocatalyst for hydrogen generation is supported on a particle-shaped semiconductor catalyst. The cocatalyst for hydrogen generation may be sheet-shaped (flake) or may be in a form of irregular colloidal particles.

In a case where the cocatalyst for oxygen generation is further contained, the cocatalyst for oxygen generation is typically in contact with the semiconductor catalyst. The cocatalyst for oxygen generation and the semiconductor catalyst may be joined to each other. The cocatalyst for oxygen generation and the semiconductor catalyst can be joined by a known method such as an impregnation method or a photo-electrodeposition method.

An amount of the cocatalyst for oxygen generation that can be contained in the photocatalyst is, for example, 0.001 to 1 part by weight, and may be 0.005 to 0.5 parts by weight, with respect to 100 parts by weight of the semiconductor catalyst.

The photocatalyst is, for example, particle-shaped. However, the shape of the photocatalyst is not limited to the above example.

The photocatalyst of the present embodiment can be formed, for example, by mixing the cocatalyst for hydrogen generation of the present embodiment and the semiconductor catalyst. The mixing may be performed in a solution, such as an aqueous solution. In an example of mixing in a solution, a particle-shaped photocatalyst is mixed with a solution in which a sheet-shaped and/or particle-shaped cocatalyst for hydrogen generation is dispersed, and then the solvent of the solution is removed to obtain a photocatalyst. The dispersed solution may be a nanocolloidal solution.

The photocatalyst of the present embodiment can be used, for example, for generating hydrogen by decomposition of water. However, the use of the photocatalyst is not limited to the above example. When viewed from an aspect in which the use is not limited, the present invention provides a semiconductor material including:

a semiconductor that is excited by light; and
a metal-organic framework (A) having a molecular structure represented by the following formula (1).

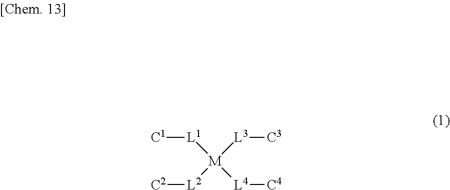

In the formula (1), M is at least one selected from Ni, Co, Fe, Cu, Zn, Pd, Pt, Au, and Ir,
L¹ to L⁴ are each independently at least one selected from S, Se, Te, NH, and O,
C₁ and C₂ are carbon atoms forming a first aromatic group, and
C₃ and C₄ are carbon atoms forming a second aromatic group.

### Application of Cocatalyst for Hydrogen Generation and Photocatalyst

Hereinafter, application examples of the cocatalyst for hydrogen generation and the photocatalyst of the present embodiment will be described. However, the mode of application of the cocatalyst for hydrogen generation and the photocatalyst is not limited to the following examples.

### Production of Hydrogen

For example, hydrogen can be produced using the cocatalyst for hydrogen generation of the present embodiment or the photocatalyst of the present embodiment. From this aspect, the present invention provides a method for producing hydrogen, the method including obtaining hydrogen using the cocatalyst for hydrogen generation of the present embodiment or the photocatalyst of the present embodiment. In addition, from the above aspect, the present invention discloses a hydrogen production apparatus including a reaction unit including the cocatalyst for hydrogen generation of the present embodiment or the photocatalyst of the present embodiment. An example of the method for producing hydrogen includes irradiating the photocatalyst of the present embodiment with ultraviolet light and/or visible light to decompose water to produce hydrogen.

### Decomposition of Water

For example, water can be decomposed using the cocatalyst for hydrogen generation of the present embodiment or the photocatalyst of the present embodiment. From this aspect, the present invention provides a method for decomposing water, the method including decomposing water using the cocatalyst for hydrogen generation of the present embodiment or the photocatalyst of the present embodiment. In addition, from the above aspect, the present invention discloses a hydrogen production apparatus (water decomposition apparatus) including a reaction unit including the cocatalyst for hydrogen generation of the present embodiment or the photocatalyst of the present embodiment. In the method for decomposing water and the hydrogen production apparatus, hydrogen alone or hydrogen and oxygen may be obtained.

Examples of a mode in which a photocatalyst is used in each of the above-described methods and apparatuses include a mode in which particles of a photocatalyst are dispersed in a solution containing water (the solution may be water), a mode in which a molded body obtained by solidifying particles of a photocatalyst is placed in a solution, and a mode in which a composite including a photocatalyst layer containing a photocatalyst (for example, a laminate of a photocatalyst layer and a substrate) is placed in a solution. The solution including water may include a sacrificial reducing agent. As the sacrificial reducing agent, for example, methanol can be used. An amount of the sacrificial reducing agent added is not particularly limited and is, for example, in a range of more than 0) vol. % and less than 100 vol. %. However, the mode of using the photocatalyst is not limited to the above example. The hydrogen production apparatus (water decomposition apparatus) may include a reaction unit accommodating a solution in which particles of a photocatalyst are dispersed, a solution in which a molded body including a photocatalyst is placed, or a solution in which a composite including a photocatalyst layer is placed. The reaction unit may be a container that can accommodate each of the above solutions and has an opening or a window through which the accommodated solution can be irradiated with light.

The molded body obtained by solidifying the particles of the photocatalyst can be formed by, for example, sintering the particles or binding the particles using a binding agent such as a resin binder. As the resin binder, a resin having an excellent binding property such as a fluororesin may be used. The photocatalyst layer containing a photocatalyst may be the above molded body. Examples of the substrate to be combined with the photocatalyst layer include metal substrates such as a stainless steel substrate and an aluminum substrate, and a glass substrate.

The photocatalyst layer and a conductive layer may be laminated to form an electrode. According to the electrode including the photocatalyst layer, generation of hydrogen and decomposition of water can be further promoted by applying a bias voltage in addition to irradiation with light. Examples of the conductive layer include a layer containing conductive particles such as carbon particles and metal particles, and a conductive sheet such as a carbon sheet and a metal sheet. The electrode can be formed by, for example, forming a coating film containing particles of the photocatalyst on the surface of the conductive layer and then drying and/or sintering the coating film. However, the generation of hydrogen and the decomposition of water by the photocatalyst of the present embodiment may be performed without applying a bias voltage, in other words, without forming an electrode.

The production apparatus may include a member other than the reaction unit. Examples of the other member include a collection unit such as a tank for collecting generated hydrogen and/or oxygen, a light source for irradiating the solution, and a water supply unit for supplying water to the reaction unit. Examples of the light source include a lamp capable of emitting light similar to sunlight, such as a xenon lamp and a metal halide lamp, a mercury lamp, and an LED. In a case of irradiation with sunlight, the production apparatus may include an optical member such as a window or a mirror that transmits sunlight and guides the sunlight to the reaction unit.

### EXAMPLES

Hereinafter, the present invention will be described in more detail with reference to examples. The present invention is not limited to the specific modes described below.

### Example 1

In Example 1, NiDT having a two-dimensional conjugated planar structure represented by the formula (4) or (4b) was prepared as the cocatalyst for hydrogen generation, and the hydrogen-generating capability and the water-decomposing capability when combined with the semiconductor catalyst were evaluated.

### Preparation of NiDT

Six mg of benzenehexathiol (BHT) was weighed in a petri dish having a diameter of 12 cm and dispersed in 150 mL of degassed dichloromethane to form a saturated solution. Degassed water was then gently dropped onto the dichloromethane layer to completely cover the surface of the dichloromethane layer with an aqueous layer. Next, 20 mL of an aqueous solution in which 20 mg of nickel acetate (Ni(OAc)₂) was dissolved was slowly added dropwise to the aqueous layer to be mixed. When allowed to stand for 24 hours, a glossy sheet-shaped NiDT was generated at a liquid-liquid interface between the dichloromethane layer and the aqueous layer. Next, the dichloromethane layer and the aqueous layer were removed by rinsing four times with pure dichloromethane and water, respectively, and then the remaining NiDT was dispersed in ethanol. Next, the NiDT dispersed in ethanol was subjected to pulverization treatment (rotation speed: 2000 rpm, treatment time: 45 minutes) using a bead mill (available from Aimex Co., Ltd., Easy Nano RMB II, bead diameter: 0.2 mm) to obtain NiDT as a fine sheet. All the above operations were carried out in a nitrogen atmosphere glovebox.

### Preparation of SrTiO₃:Al

With reference to Chem. Rev. 2020, 120, 8536, SrTiO₃ synthesized by a solid phase method was doped with Al by a molten salt method to prepare SrTiO₃:Al. Specifically, the preparation method is as follows. Dried SrCO₃ powder (1.48 g. 0.01 mol) and dried TiO₂ powder (0.799 g, 0.01 mol) were mixed for 15 minutes using an agate mortar. The mixed powder was placed in a crucible made of alumina and fired at 1373 K for 10 hours using an electric furnace to obtain powder of SrTiO₃ as a precursor. Generation of SrTiO₃ was confirmed by X-ray diffraction. Next, the obtained SrTiO₃ powder, SrCl₂·6H₂O powder, and Al₂O₃ powder were mixed at a mixing ratio (molar ratio) of 1:10:0.02, and further mixed for 15 minutes using a mortar. The mixed powder was placed in a crucible made of alumina and fired at 1373 K for 10 hours using an electric furnace to obtain powder of SrTiO₃:Al. The obtained powder was washed three times with Milli-Q water (400 mL) and then dried overnight in a vacuum dryer.

Support of CoOₓ Particles on SrTiO₃:Al Powder

In accordance with J. Phys. Chem. B 2003, 107, 7965, an aqueous cobalt nitrate (Co(NO₃)₂) solution as a precursor solution (Co content: 0.5 wt. %) and NaIO₃ (0.01 mol) as an oxidation sacrificial agent were used to support CoOₓ particles as the cocatalyst for oxygen generation on SrTiO₃:Al powder by a photo-deposition method. The amount of CoOₓ supported was 0.5 wt. % as Co. A xenon lamp (power: 300 W, wavelength λ>300 nm) was used as the light source and the irradiation time was 2 hours. The powder after light irradiation was washed three times with each of Milli-Q water (400 mL) and ethanol (50 mL), and then dried overnight in a vacuum drier. Hereinafter, SrTiO₃:Al on which CoOₓ is supported is referred to as CoOₓ/SrTiO₃:Al.

Support of NiDT on SrTiO₃:Al and CoOₓ/SrTiO₃:Al

NiDT was supported on SrTiO₃:Al and CoOₓ/SrTiO₃:Al by an impregnation method. Specifically, the supporting method is as follows. SrTiO₃:Al (or CoOₓ/SrTiO₃:Al) was placed in an evaporating dish, and an ethanol dispersion of NiDT (NiDT content: 1 wt. %) was added thereto. Next, the mixed solution was evaporated to dryness in a hot water bath while being stirred using a glass rod to obtain powder of SrTiO₃:Al (or CoOₓ/SrTiO₃: Al) on which NiDT was supported. The amount of NiDT supported was 1 wt. % in each case. Hereinafter, a sample in which only NiDT is supported on SrTiO₃:Al is referred to as NiDT/SrTiO₃:Al, and a sample in which NiDT and CoOₓ are co-supported on SrTiO₃:Al is referred to as NiDT/CoOₓ/SrTiO₃:Al.

### Confirmation of SrTiO₃:Al, NiDT, and Support State of NiDT by SEM

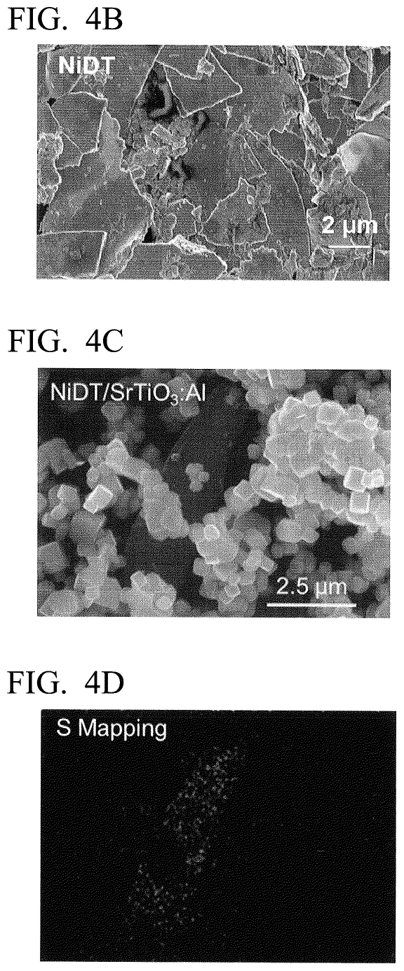

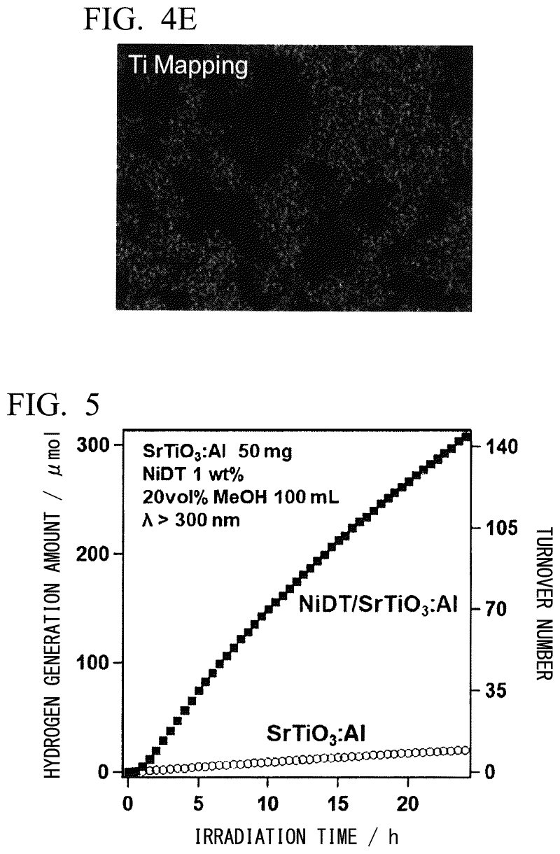

Shapes of SrTiO₃:Al, NiDT, and NiDT/SrTiO₃:Al, and a state of NiDT supported on SrTiO₃:Al were confirmed by observation using SEM (available from Carl Zeiss-SII Nano Technology, NVision 40) and elemental mapping using energy dispersive X-ray spectroscopy (EDX). Observation images of SrTiO₃:Al, NiDT, and NiDT/SrTiO₃:Al by SEM are shown in FIG. 4A, FIG. 4B, and FIG. 4C, respectively. Mapping of elemental sulfur and mapping of elemental titanium on NiDT/SrTiO₃:Al are shown in FIG. 4D and FIG. 4E, respectively. As shown in FIG. 4A to FIG. 4E, it was confirmed that in the prepared NiDT/SrTiO₃:Al, sheet-shaped NiDT was supported on particle-shaped SrTiO₃:Al. In addition, it was confirmed that NiDT was a laminate of nanosheets.

### Evaluation of Hydrogen-Generating Capability by Photocatalytic Reaction

For each of unmodified SrTiO₃:Al and NiDT/SrTiO₃:Al, a hydrogen (H₂) generating capability by a photocatalytic reaction was evaluated. Evaluation was conducted by accommodating each powder (0.05 g) to be evaluated, Milli-Q water (80 mL), and methanol (20 mL) in a side-irradiation type cell (capacity: 192 mL) made of Pyrex (borosilicate glass) and performing irradiation with light including ultraviolet light (wavelength λ>300 nm) from a xenon lamp (power: 300 W). That is, the side-irradiation type cell accommodating each powder, Milli-Q water and methanol was connected to a closed circulation system, and then light including ultraviolet light was applied from a side surface of the side-irradiation type cell while stirring and mixing each powder, Milli-Q water, and methanol using a magnetic stirring bar and a magnetic stirrer. Gas generated by the light irradiation was analyzed with time by a gas chromatograph connected to the closed circulation system. FIG. 5 shows changes over time in the amount of hydrogen generated in a case where each of unmodified SrTiO₃:Al and NiDT/SrTiO₃:Al was used as the photocatalyst. Note that methanol was used as a sacrificial reducing agent for capturing holes (h) generated in SrTiO₃:Al. The high efficiency of methanol as the sacrificial reducing agent is well known to those skilled in the art.

As shown in FIG. 5, in the case where unmodified SrTiO₃:Al was used, generation of 20 μmol of hydrogen was confirmed in 24 hours. On the other hand, in the case where NiDT/SrTiO₃:Al was used, generation of 308 μmol of hydrogen, which was about 15 times, was confirmed. In other words, it was confirmed that the activity of SrTiO₃:Al for the generation of hydrogen was greatly improved by supporting NiDT. For NiDT/SrTiO₃:Al, a turnover number (TON) based on NiDT in the reaction for 24 hours was calculated to be 145. Such a large TON clearly indicates that the generation of hydrogen comes from the decomposition of water rather than from the decomposition of NiDT. From the above results, it was confirmed that NiDT functions as the cocatalyst for hydrogen generation.

### Electrochemical Measurement of Hydrogen Generation Overvoltage

For each of unmodified SrTiO₃:Al and NiDT/SrTiO₃:Al, a hydrogen generation overvoltage was evaluated by electrochemical measurement. The evaluation was performed as follows.

To a glassy carbon (GC) electrode available from BAS, 24 μL of an ethanol dispersion (5 mg/mL) of unmodified SrTiO₃:Al or NiDT/SrTiO₃:Al was added dropwise, followed by drying overnight to prepare a working electrode. Next, linear sweep voltammetry (LSV) measurement was performed using a Pt wire as a counter electrode, a silver/silver chloride electrode as a reference electrode, and a phosphate buffer solution (pH=7) as an electrolytic solution. Note that before the measurement, argon gas was bubbled for 30 minutes to remove dissolved oxygen in the electrolytic solution. The LSV measurement results for unmodified SrTiO₃:Al and NiDT/SrTiO₃:Al are shown in FIG. 6. As shown in FIG. 6, a significant decrease was observed in the hydrogen generation overvoltage of NiDT/SrTiO₃:Al as compared with unmodified SrTiO₃:Al. The decrease in hydrogen generation overvoltage means a decrease in activation energy required for hydrogen generation, in other words, it means that NiDT functioned as an activation site for hydrogen generation.

### Evaluation of Water-Decomposing Capability by Photocatalytic Reaction

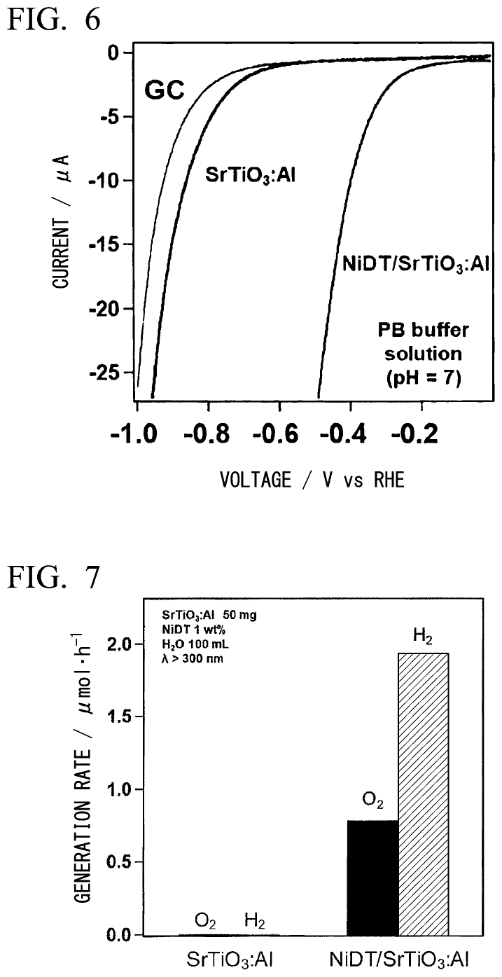

For each of unmodified SrTiO₃:Al and NiDT/SrTiO₃:Al, a water-decomposing capability by the photocatalytic reaction was evaluated. Evaluation was conducted by accommodating each powder (0.05 g) to be evaluated and Milli-Q water (100 mL) in a side-irradiation type cell made of Pyrex and performing irradiation with light including ultraviolet light (wavelength λ>300 nm) from a xenon lamp (power: 300 W) in the same manner as described above. Gas generated by the light irradiation was analyzed with time by a gas chromatograph connected to the closed circulation system. FIG. 7 shows generation rates of hydrogen and oxygen in the case where each of unmodified SrTiO₃:Al and NiDT/SrTiO₃: Al was used as the photocatalyst. As shown in FIG. 7, in the case where unmodified SrTiO₃: Al was used, almost no gas generation was observed. On the other hand, in the case where NiDT/SrTiO₃:Al was used, decomposition of water proceeded, and hydrogen and oxygen were generated at a substantially stoichiometric ratio (2:1).

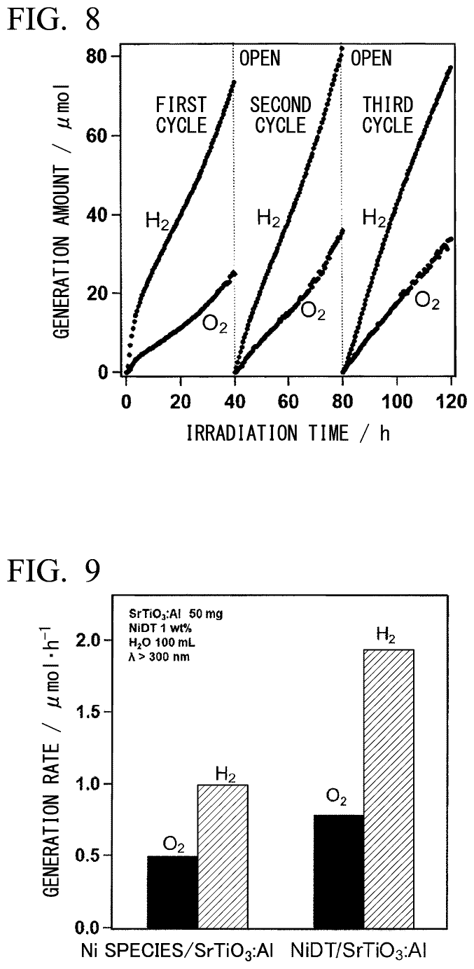

Next, with 40 hours as one cycle, the light irradiation was performed for three cycles. Between the cycles, the light irradiation was temporarily stopped and gas inside the closed circulation system was released. FIG. 8 shows changes over time in amounts of hydrogen and oxygen generated in a case where NiDT/SrTiO₃:Al was used. As shown in FIG. 8, even when the reaction was continued for three cycles (120 hours), a decrease in the gas generation rate was hardly observed. Note that at the end of the first cycle, a ratio of hydrogen to oxygen generated was about 3:1, and from this, it was estimated that holes (h) corresponding to about 47.5 μmol were not used for oxidation of water. The amount was much larger than the amount of substance (2.13 μmol) of NiDT used, and thus it was considered that the holes were used for oxidation of the organic substance remaining on the surface of the SrTiO₃:Al powder.

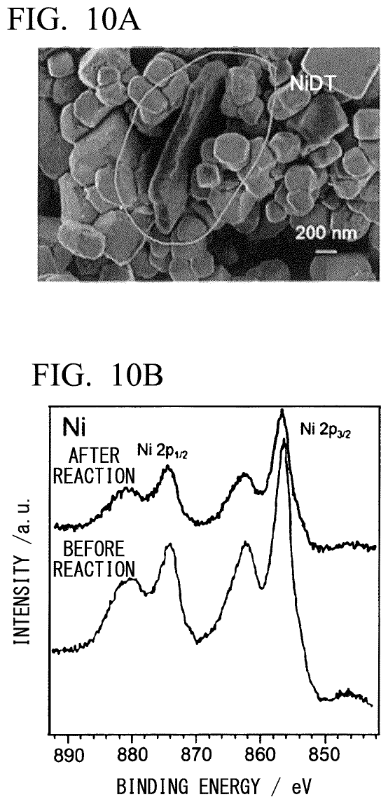

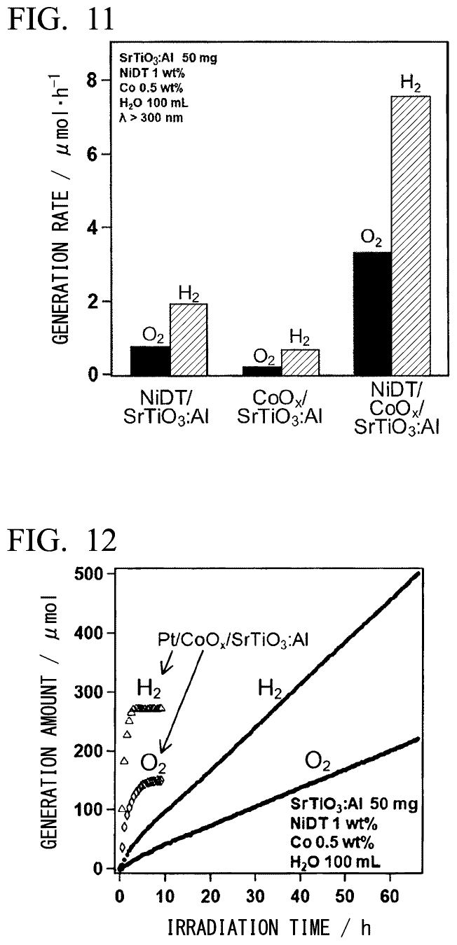

Next, to further examine stability of NiDT, for a case where unmodified SrTiO₃:Al was used, and an aqueous solution of nickel nitrate (Ni(NO₃)₂) as a Ni species (Ni content: 0.25 wt. %) was further added to the reaction solution, the generation rates of hydrogen and oxygen by decomposition of water were evaluated as described above. As shown in FIG. 9, also in the case where Ni species (Ni²⁺ ions) were added to the reaction solution, the decomposition reaction of water proceeded and hydrogen and oxygen were generated. However, higher activity was obtained in the case where NiDT/SrTiO₃:Al was used (see FIG. 9), and thus it was considered that possibility that decomposition of water was promoted by elution of Ni species from NiDT was low. In addition, when observation by SEM and evaluation of a peak derived from Ni by EDX were performed on NiDT/SrTiO₃:Al after a decomposition reaction of water for 120 hours, as shown in FIG. 10A (observation image by SEM) and FIG. 10B (EDX profile), a large change was not confirmed in the shape of NiDT and the oxidized state of Ni in NiDT. From the above results, it was confirmed that NiDT stably functioned as a cocatalyst in the decomposition reaction of water.

### Effect due to Co-Support of Oxidation Cocatalyst CoOₓ

The generation rates of hydrogen and oxygen by decomposition of water were evaluated in the same manner as described above except that NiDT/CoOₓ/SrTiO₃:Al was used as the photocatalyst. The evaluated generation rates are shown in FIG. 11 together with the generation rates of hydrogen and oxygen in a case where each of CoOₓ/SrTiO₃:Al and NiDT/SrTiO₃:Al is used as the photocatalyst. As shown in FIG. 11, in the case where NiDT/CoOₓ/SrTiO₃:Al was used as the photocatalyst, the generation rates achieved about 11 times and 4 times as high as that obtained in the case where CoOₓ/SrTiO₃:Al was used as the photocatalyst and that obtained in the case where NiDT/SrTiO₃:Al was used as the photocatalyst, respectively. In other words, it was confirmed that co-support with the oxidation cocatalyst was an effective means for improving the activity for the decomposition reaction of water.

### Evaluation of Activity Against Reverse Reaction

Changes over time in the amounts of hydrogen and oxygen generated by decomposition of water were measured in the same manner as described above except that NiDT/CoOₓ/SrTiO₃:Al and Pt/CoOₓ/SrTiO₃:Al(SrTiO₃:Al powder on which Pt particles and CoOₓ particles were co-supported) were used as the photocatalyst. The measurement results are indicated in FIG. 12. As shown in FIG. 12, in a case where Pt was used as a reduction cocatalyst, high generation rates of hydrogen and oxygen were obtained only at the initial stage of the reaction, but the gas generation apparently stopped after several hours. It was presumed that this was because the generated hydrogen and oxygen were accumulated and a rate of a reverse reaction of water decomposition (H₂+O₂→H₂O) was increased. In contrast, in a case where NiDT was used as the reduction cocatalyst, the generation of hydrogen and oxygen continued at a constant rate. This result suggested that NiDT does not have activity as a cocatalyst for the reverse reaction.

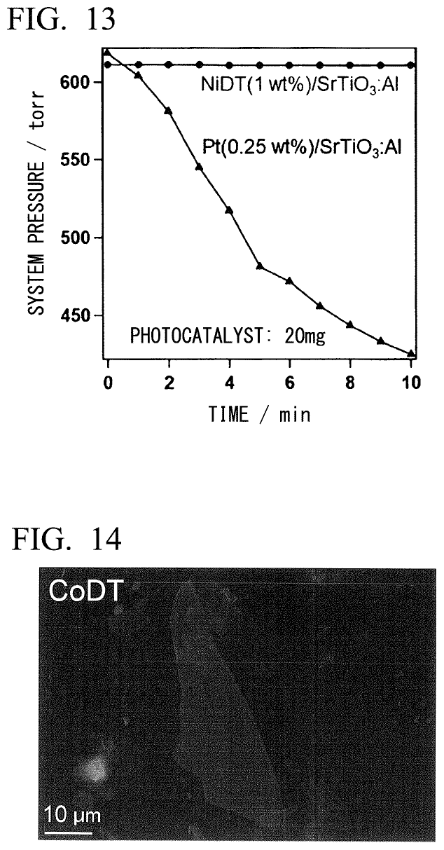

To verify this, evaluation of the activity for the reverse reaction was conducted. Evaluation was conducted in a gas phase by accommodating, as the photocatalyst, NiDT/SrTiO₃:Al and Pt/SrTiO₃:Al(SrTiO₃:Al powder on which Pt particles were supported) (both 0.02 g) in a reaction vessel made of Pyrex. Specifically, the reaction vessel accommodating the photocatalyst was connected to a closed circulation system, then hydrogen gas (pressure: 180 Torr) and air (pressure: 450 Torr) were introduced into the closed circulation system connected to the reaction vessel in such a manner that the volumetric ratio of hydrogen to oxygen was 2:1, and the change in atmospheric pressure in the circulation system was measured with time in the dark without light irradiation. The measurement results are indicated in FIG. 13. As shown in FIG. 13, in the case where Pt/SrTiO₃:Al was used, the atmospheric pressure in the circulation system was significantly reduced, whereas in the case where NiDT/SrTiO₃:Al was used, almost no change was confirmed in the atmospheric pressure in the circulation system. From the above results, it was confirmed that NiDT is inactive as a cocatalyst for the reverse reaction. Pt/SrTiO₃:Al and Pt/CoOₓ/SrTiO₃:Al (both with a supported Pt amount of 0.25 wt. %) were prepared in accordance with Energy Environ. Sci., 2016, 9, 2463-2469.

From Example 1, it was confirmed that NiDT was a cocatalyst for hydrogen generation also having reaction selectivity as a molecular catalyst.

### Example 2

In Example 2, CoDT having a two-dimensional conjugated planar structure represented by the formula (4) was prepared as the cocatalyst for hydrogen generation, and the hydrogen-generating capability and the water-decomposing capability when combined with the semiconductor catalyst were evaluated.

### Preparation of CoDT

In a petri dish having a diameter of 12 cm, 2 mg of BHT was weighed and dispersed in 70 mL of degassed dichloromethane to give a saturated solution. Then, degassed water (about 40 mL) was gently dropped on the dichloromethane layer to completely cover the dichloromethane layer with an aqueous layer. Next, 2 mL of an aqueous solution in which 40 mg of cobalt chloride (CoCl₂·6H₂O) was dissolved was slowly added dropwise to the aqueous layer to be mixed. When the aqueous solution was added dropwise four times in total and then allowed to stand for 48 hours, a glossy sheet-shaped CoDT was generated at the liquid-liquid interface between the dichloromethane layer and the aqueous layer. The dichloromethane layer and the aqueous layer were then removed by rinsing four times with pure dichloromethane and water, respectively, and the remaining CoDT was then dispersed in ethanol. The CoDT collected by filtration was subjected to ultrasonic treatment for 30 minutes to obtain a fine sheet of CoDT. An observation image of the obtained CoDT by SEM is shown in FIG. 14. The obtained CoDT was dispersed again in ethanol (30 mL). All the above operations were carried out in a nitrogen atmosphere glovebox.

Support of CoDT on SrTiO₃:Al) The support of CoDT on SrTiO₃:Al was carried out by an impregnation method in the same manner as the support of NiDT on SrTiO₃:Al in Example 1. Hereinafter, a sample in which CoDT is supported on SrTiO₃:Al is referred to as CoDT/SrTiO₃:Al.

### Evaluation of Water-Decomposing Capability by Photocatalytic Reaction

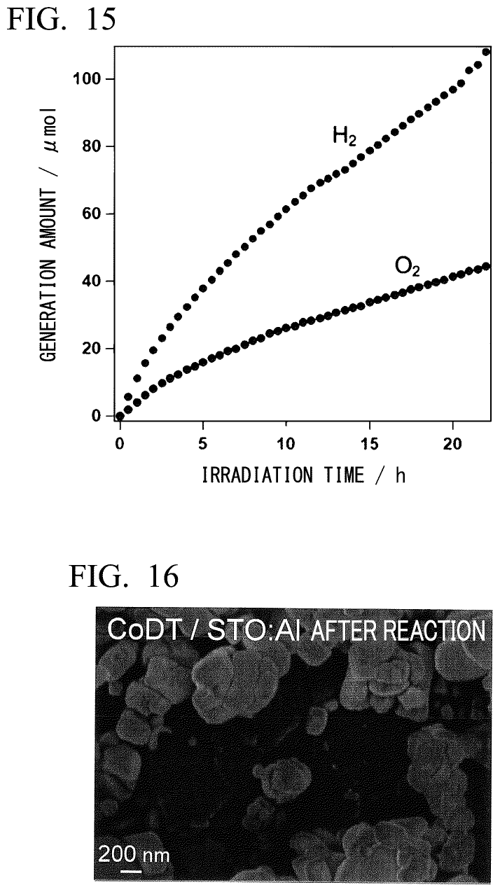

For CoDT/SrTiO₃:Al, the water-decomposing capability by the photocatalytic reaction was evaluated. Evaluation was conducted by accommodating powder (0.05 g) of the sample to be evaluated and Milli-Q water (100 mL) in a side-irradiation type cell made of Pyrex, and applying light including ultraviolet light (wavelength λ>300 nm) from a xenon lamp (power: 300 W) in the same manner as described above. Gas generated by the light irradiation was analyzed with time by a gas chromatograph connected to the closed circulation system. FIG. 15 shows changes over time in amounts of hydrogen and oxygen generated in a case where CoDT/SrTiO₃:Al was used as the photocatalyst. As shown in FIG. 15, generation of hydrogen and oxygen was confirmed. FIG. 16 shows an observation image by SEM of CoDT/SrTiO₃:Al used in the water decomposition reaction for 22 hours. As shown in FIG. 16, no significant change was observed in the shape of CoDT.

### Example 3

In Example 3, nanocolloids of NiDT having the two-dimensional conjugated planar structure represented by the formula (4) or (4b) were prepared as the catalyst for hydrogen generation, and the hydrogen-generating capability and the water-decomposing capability were evaluated when the nanocolloids were combined with the semiconductor catalyst.

### Preparation of NiDT Nanocolloid [NiDT-NCs]

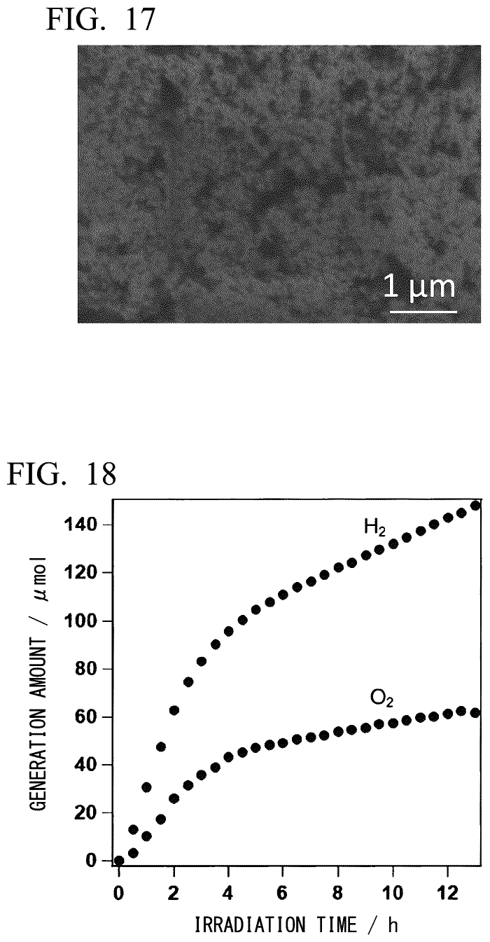

In an eggplant flask having a capacity of 100 mL, 4.1 mg (0.015 mmol) of BHT and 6.5 mg (0.045 mmol) of benzene-1,2-dithiol (bdt) were weighed and dispersed in 50 mL of degassed dichloromethane to give a saturated solution. Separately from the above, 11.2 mg (0.045 mmol) of (CH₃COO)₂Ni·4H₂O was weighed in another eggplant flask having a capacity of 50 mL, and dissolved in 50 mL of a degassed ammonia-ethanol mixed solvent (concentration: 0.2 mol/L). Next, a (CH₃COO)₂Ni solution was slowly added dropwise to the saturated solution and then allowed to stand for 12 hours to obtain a black NiDT nanocolloid (NiDT-NCs) solution. All the above operations were carried out in a nitrogen atmosphere glovebox. FIG. 17 shows an observation image by SEM of a solid content collected by filtration from the NiDT-NCs solution.

Support of NiDT-NCs on SrTiO₃:Al and CoOₓ/SrTiO₃:Al

The support of NiDT-NCs on SrTiO₃:Al and CoOₓ/SrTiO₃:Al was carried out by the impregnation method in the same manner as the support of NiDT on SrTiO₃:Al and CoOₓ/SrTiO₃:Al in Example 1 except that the prepared NiDT-NCs solution (NiDT-NCs content: 1 wt. %) was used instead of the ethanol dispersion of NiDT. Hereinafter, a sample in which only NiDT-NCs is supported on SrTiO₃:Al is referred to as NiDT-NCs/SrTiO₃:Al, and a sample in which NiDT-NCs and CoOₓ are co-supported on SrTiO₃:Al is referred to as NiDT-NCs/CoOₓ/SrTiO₃:Al.

### Evaluation of Water-Decomposing Capability by Photocatalytic Reaction

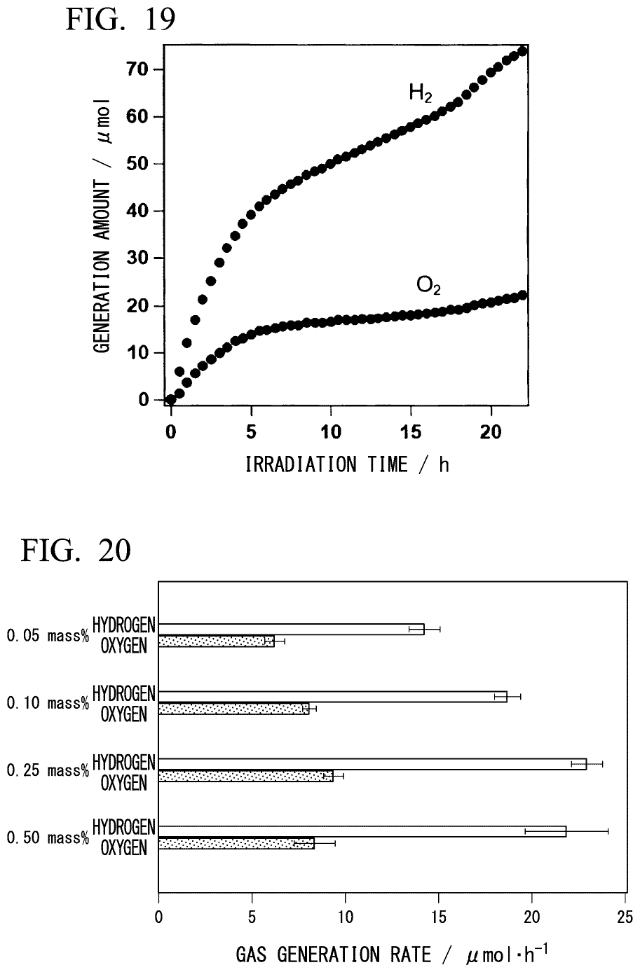

For each of NiDT-NCs/SrTiO₃:Al and NiDT-NCs/CoOₓ/SrTiO₃:Al, the water-decomposing capability by the photocatalytic reaction was evaluated. Evaluation was conducted by accommodating powder of the sample to be evaluated (0.05 g) and Milli-Q water (100 mL) in an upward-irradiation type cell made of Pyrex and applying light including ultraviolet light (wavelength λ>300 nm) from a xenon lamp (power: 300 W). That is, the upward-irradiation type cell accommodating each powder, Milli-Q water and methanol was connected to a closed circulation system, and then light including ultraviolet light was applied from an upper surface of the upward-irradiation type cell while stirring each powder, Milli-Q water, and methanol using a magnetic stirring bar and a magnetic stirrer. Gas generated by the light irradiation was analyzed with time by a gas chromatograph connected to the closed circulation system. FIG. 18 shows changes over time in amounts of hydrogen and oxygen generated in a case where NiDT-NCs/CoOₓ/SrTiO₃:Al was used as the photocatalyst. FIG. 19 shows changes over time in amounts of hydrogen and oxygen generated in a case where NiDT-NCs/SrTiO₃:Al was used as the photocatalyst. As shown in FIGS. 18 and 19, generation of hydrogen and oxygen was observed.

### Example 4

In Example 4, the hydrogen-generating capability and the water-decomposing capability when the amount of NiDT-NCs added to the semiconductor catalyst was changed were evaluated.

Support of NiDT-NCs on CoOₓ/SrTiO₃:Al

The support was carried out in the same manner by an impregnation method as the support of NiDT-NCs on CoOₓ/SrTiO₃:Al in Example 3 except that the amount of the NiDT-NCs solution (NiDT-NCs content: 1 wt. %) added to CoOₓ/SrTiO₃:Al was adjusted to 0.05 wt. %, 0.10 wt. %, 0.25 wt. %, and 0.50 wt. % in terms of the amount of NiDT-NCs in the NiDT-NCs solution relative to SrTiO₃:Al.

### Evaluation of Water-Decomposing Capability by Photocatalytic Reaction

For each of NiDT-NCs/CoOₓ/SrTiO₃:Al, the water-decomposing capability by the photocatalytic reaction was evaluated. Evaluation was conducted by accommodating powder (0.05 g) of the sample to be evaluated and Milli-Q water (100 mL) in a side-irradiation type cell made of Pyrex, and applying light including ultraviolet light (wavelength λ>300 nm) from a xenon lamp (power: 300 W) in the same manner as described above. Gas generated by the light irradiation was analyzed with time by a gas chromatograph connected to the closed circulation system. An analysis time and an amount of gas generated were plotted to create a time-gas generation amount graph, and the gas generation rates of the gases (hydrogen and oxygen) were calculated from the obtained graph. The gas generation rates are shown in FIG. 20. It was confirmed that the generation rates of hydrogen and oxygen gases in the case where NiDT-NCs/CoOₓ/SrTiO₃:Al was used as the photocatalyst were the highest when the amount of NiDT-NCs added to SrTiO₃:Al was 0.25 wt. %.

### Example 5

In Example 5, CuCo-CAT having the two-dimensional conjugated planar structure represented by the formula (5) or (5a) was prepared as the catalyst for hydrogen generation, and the hydrogen-generating capability and the water-decomposing capability when combined with the semiconductor catalyst were evaluated.

### Preparation of CuCo-CAT

Synthesis of CuCo-CAT was carried out in accordance with a previous report (Adv. Mater. 2021, 33, 2106781). 0.15 mmol of Cu(OAc)₂:H₂O, 0.15 mmol of Co(OAc)₂·4H₂O, and 0.15 mmol of hexahydroxytriphenylene were suspended in 5 mL of a mixed solvent of water/dimethylformamide (1/1=v/v), sealed in a sealed vessel made of borosilicate glass, and subjected to ultrasonic treatment for 10 minutes. The obtained suspension was heated at 85° C. for 24 hours. Then, CuCo-CAT obtained as a black-blue precipitate was separated by filtration, washed with dimethylformamide, acetone, and methanol, and vacuum-dried for 24 hours. CuCo-CAT was refined as follows. 50 mg of CuCo-CAT was dispersed in 30 mL of methanol together with 170 g of zirconia beads of 100 μmφ, and pulverization treatment was performed at 2500 rpm for 2 hours using a bead mill (available from Aimex Co., Ltd., Easy Nano RMB II). The obtained suspension was filtered through a qualitative filter paper (available from ADVANTEC Co., Ltd., 2A (retained particle size: 5 μm)) to recover a filtrate containing refined CuCo-CAT.

Support of CuCo-CAT on SrTiO₃:Al and CoOₓ/SrTiO₃:Al

The support of CuCo-CAT on SrTiO₃:Al and CoOₓ/SrTiO₃:Al was carried out by an impregnation method. Specifically, the supporting method is as follows. SrTiO₃:Al (or CoOₓ/SrTiO₃:Al) was placed in an evaporating dish, and a methanol dispersion of CuCo-CAT (content of CuCo-CAT: 0.5 wt. %) was added thereto. Next, the mixed solution was evaporated to dryness in a hot water bath while being stirred using a glass rod to obtain powder of SrTiO₃:Al (or CoOₓ/SrTiO₃:Al) on which CuCo-CAT was supported. The amount of CuCo-CAT supported was 0.5 wt. % in each case. Hereinafter, a sample in which only CuCo-CAT is supported on SrTiO₃:Al is referred to as CuCo-CAT/SrTiO₃:Al, and a sample in which CuCo-CAT and CoOₓ are co-supported on SrTiO₃:Al is referred to as CuCo-CAT/CoOₓ/SrTiO₃:Al. The support of CoOₓ on SrTiO₃:Al was carried out in the same manner as in Example 1 except that the content of Co in the aqueous cobalt nitrate solution was changed to 0.1 wt. % and the amount of CoOₓ supported was 0.1 wt. % as Co.

### Evaluation of Water-Decomposing Capability by Photocatalytic Reaction

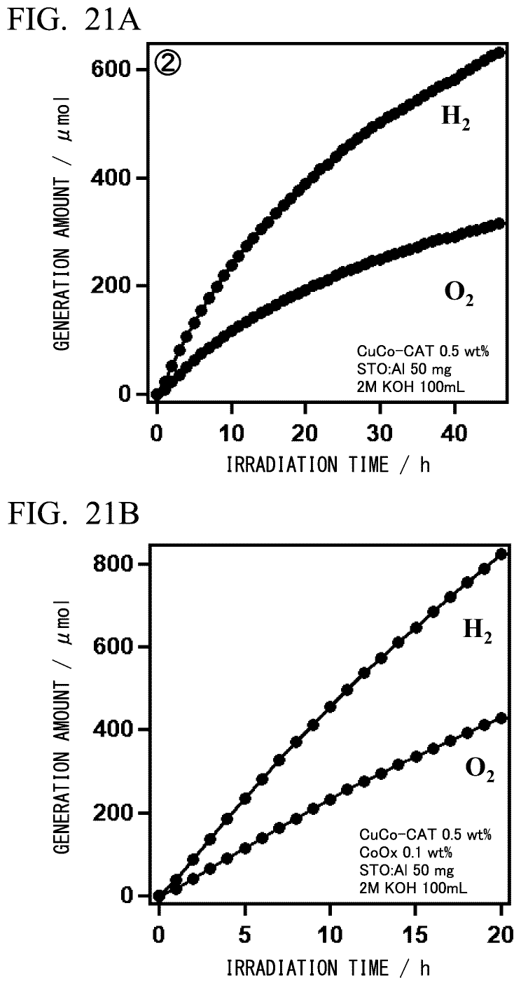

For CuCo-CAT/SrTiO₃:Al and CuCo-CAT/CoOₓ/SrTiO₃:Al, the water-decomposing capability by the photocatalytic reaction was evaluated. Evaluation was conducted by accommodating powder (0.05 g) of the sample to be evaluated and Milli-Q water (100 mL) in a side-irradiation type cell made of Pyrex, and applying light including ultraviolet light (wavelength λ>300 nm) from a xenon lamp (power: 300 W) in the same manner as described above. Gas generated by the light irradiation was analyzed with time by a gas chromatograph connected to the closed circulation system. FIG. 21A shows changes over time in amounts of hydrogen and oxygen generated in a case where CuCo-CAT/SrTiO₃: Al was used as the photocatalyst, and FIG. 21B shows changes over time in amounts of hydrogen and oxygen generated in a case where CuCo-CAT/CoOₓ/SrTiO₃:Al was used as the photocatalyst. As shown in FIG. 21A and FIG. 21B, generation of hydrogen and oxygen was confirmed also in the combination of CuCo-CAT and SrTiO₃:Al.

### Example 6

In Example 6, CuNi-CAT having a two-dimensional conjugated planar structure represented by the formula (5) (obtained by substituting Co of CuCo-CAT represented by the formula (5a) with Ni) was prepared as the catalyst for hydrogen generation, and the hydrogen-generating capability and the water-decomposing capability when combined with the semiconductor catalyst were evaluated.

### Direct Synthesis of CuNi-CAT on SrTiO₃:Al

Direct synthesis of CuNi-CAT on the surface of SrTiO₃:Al was carried out with reference to a previous report (Adv. Mater. 2021, 33, 2106781). 0.05 mmol of Cu(OAc)₂·H₂O, 0.05 mmol of Ni(OAc)₂·4H₂O, 0.05 mmol of hexahydroxytriphenylene, 150) mg of SrTiO₃:Al, and 8 mL of a mixed solvent of water/dimethylformamide (1/1=v/v) were suspended in a 30 mL glass vial and subjected to ultrasonic treatment for 10 minutes. The obtained suspension was transferred to a Teflon (trade name) vessel for hydrothermal synthesis (capacity: 100 mL) and heated at 85° C. for 10 hours. Then, the suspension was centrifuged, and SrTiO₃:Al modified with CuNi-CAT was separated by filtration, washed five times with Milli-Q water, and vacuum-dried for 24 hours. Hereinafter, this sample will be referred to as CuNi-CAT/SrTiO₃:Al.

### Evaluation of Water-Decomposing Capability by Photocatalytic Reaction

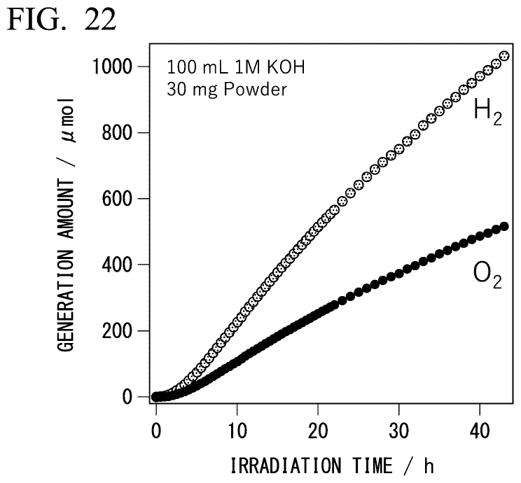

For CuNi-CAT/SrTiO₃:Al, the water-decomposing capability by the photocatalytic reaction was evaluated. Evaluation was conducted by accommodating powder of the sample to be evaluated (0.03 g) and 1 M (100 mL) of an aqueous KOH solution in a side-irradiation type cell made of Pyrex and applying light including ultraviolet light (wavelength λ>300 nm) from a xenon lamp (power: 300 W) in the same manner as described above. Gas generated by the light irradiation was analyzed with time by a gas chromatograph connected to the closed circulation system. FIG. 22 shows changes over time in amounts of hydrogen and oxygen generated in a case where CuNi-CAT/SrTiO₃:Al was used as the photocatalyst. As shown in FIG. 22, the generation of hydrogen and oxygen was confirmed also in the combination of CuNi-CAT and SrTiO₃:Al.

### INDUSTRIAL APPLICABILITY

The cocatalyst for hydrogen generation of the present invention can be used in, for example, a photoreaction apparatus such as a hydrogen production apparatus that produces hydrogen by irradiation with light and a water decomposition apparatus that decomposes water by irradiation with light.

### REFERENCE SIGNS LIST

1 Semiconductor material
2 Light
12 Valence band
13 Conduction band

1. A cocatalyst for hydrogen generation to be combined with a semiconductor catalyst that is excited by light, the cocatalyst for hydrogen generation comprising
a metal-organic framework having a molecular structure represented by the following formula (1): 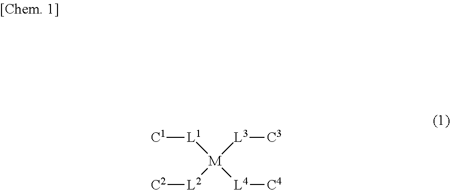
where M is at least one selected from Ni, Co, Fe, Cu, Zn, Pd, Pt, Au, and Ir,
L¹ to L⁴ are each independently at least one selected from S, Se, Te, NH, and O,
C₁ and C₂ are carbon atoms forming a first aromatic group, and
C₃ and C₄ are carbon atoms forming a second aromatic group.

2. The cocatalyst for hydrogen generation according to claim 1, wherein the M is at least one selected from Ni, Co, and Cu.

3. The cocatalyst for hydrogen generation according to claim 1, wherein the L¹ to L⁴ are each independently at least one selected from S, Se, Te, and O.

4. The cocatalyst for hydrogen generation according to claim 1, wherein all of the L¹ to L⁴ are identical.

5. The cocatalyst for hydrogen generation according to claim 1, wherein at least one selected from the first aromatic group and the second aromatic group is a group represented by the following formula (2a) or formula (2b):

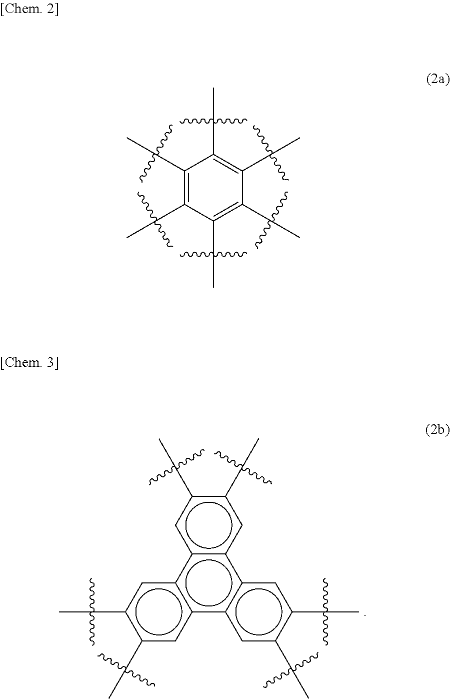

6. The cocatalyst for hydrogen generation according to claim 1, wherein the metal-organic framework has two or more of the molecular structures.

7. The cocatalyst for hydrogen generation according to claim 1, wherein the metal-organic framework has a molecular structure represented by the following formula (4) or (5): 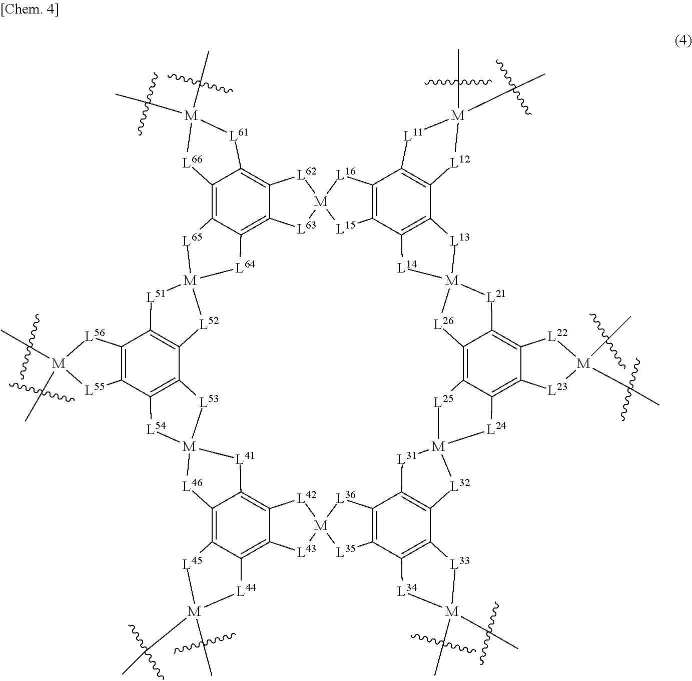 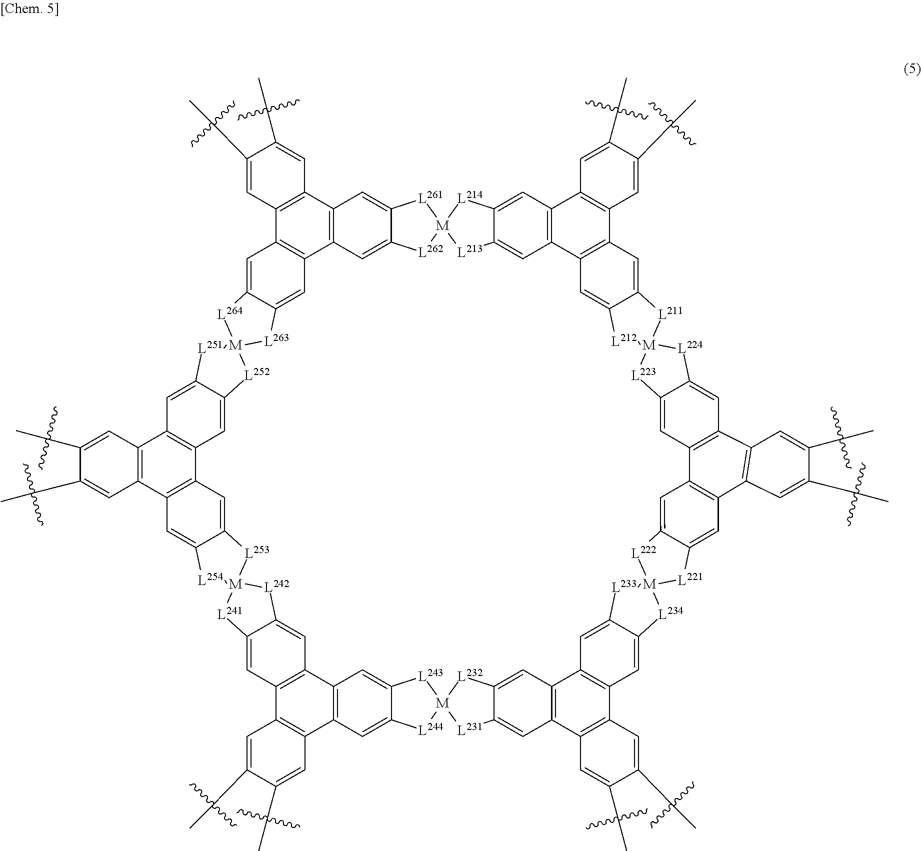
where M in the formula (4) is identical to M in the formula (1), L¹¹ to L¹⁶, L²¹ to L²⁶, L³¹ to L³⁶, L⁴¹ to L⁴⁶, L⁵¹ to L⁵⁶, and L⁶¹ to L⁶⁶ are each independently an atom of a possible element of L¹ to L⁴ in the formula (1),
M in the formula (5) is identical to M in the formula (1), and L²¹¹ to L²¹⁴, L²²¹ to L²²⁴, L²³¹ to L²³⁴, L²⁴¹ to L²⁴⁴, L²⁵¹ to L²⁵⁴, and L²⁶¹ to L²⁶⁴ are each independently an atom of a possible element of L¹ to L⁴ in the formula (1).

8. The cocatalyst for hydrogen generation according to claim 1, wherein the cocatalyst for hydrogen generation is a nanosheet including the metal-organic framework, or a laminate including the nanosheets laminated.

9. A photocatalyst comprising:
a semiconductor catalyst that is excited by light; and
a cocatalyst for hydrogen generation described in claim 1.

10. The photocatalyst according to claim 9, wherein an energy at a lower end of a conduction band in the semiconductor catalyst is negatively larger than a reduction potential of water.

11. The photocatalyst according to claim 10, wherein an energy at an upper end of a valence band in the semiconductor catalyst is positively larger than an oxidation potential of water.

12. The photocatalyst according to any claim 9, wherein the semiconductor catalyst is at least one selected from the group consisting of SrTiO₃, K₂Ti₆O₁₃, TiO₂, Nb₂O₅, KTaO₃/KNbO₃ solid solution, ZnO, ZrO₂, GaP, GaN, Si, CdS, CdSe, C₃N₄, and metal-doped forms thereof.

13. A method for producing hydrogen, the method comprising
irradiating the photocatalyst described in claim 9 with light including at least one selected from ultraviolet light, visible light, and near-infrared light to decompose water to produce hydrogen.

14. A hydrogen production apparatus comprising
a reaction unit including the photocatalyst described in claim 9.

15. A semiconductor material comprising:
a semiconductor that is excited by light; and
a metal-organic framework having a molecular structure represented by the following formula (1): 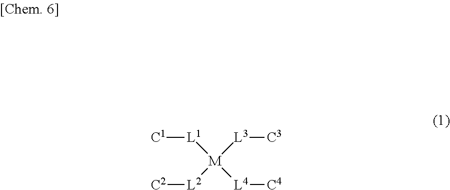
where M is at least one selected from Ni, Co, Fe, Cu, Zn, Pd, Pt, Au, and Ir,
L¹ to L⁴ are each independently at least one selected from S, Se, Te, NH, and O,
C¹ and C² are carbon atoms forming a first aromatic group, and
C³ and C⁴ are carbon atoms forming a second aromatic group.
